(19) United States
(12) Patent Application Publication
(10) Pub. No.: US 2026/0343348 A1
(43) Pub. Date: Oct. 29, 2026

(54) MANAGING DATA COMMUNICATION IN A SERVING CELL CHANGE SCENARIO

(71) Applicant: GOOGLE LLC, Mountain View, CA (US)

(72) Inventor: Chih-Hsiang Wu, Taoyuan City (TW)

(21) Appl. No.: 19/116,190

(22) PCT Filed: Sep. 29, 2023
(86) PCT No.: PCT/US2023/034218

§ 371 Date: Mar. 27, 2025

(51) Int. Cl. H04W 36/02; H04W 36/00; H04W 36/08

(52) U.S. Cl. CPC H04W 36/02; H04W 36/0055; H04W 36/08

(57) ABSTRACT

A CU of a distributed base station, which includes the CU and a distributed unit DU, transmits (1006), to a user equipment UE via the DU and in a first cell, a configuration for performing a serving cell change to a second cell subsequent to an activation command; and in response to receiving (1008, 1009) a DU-to-CU message subsequent to the transmitting of the configuration but prior to receiving an indication that the UE has connected to the second cell, suspends (1010) DE transmissions of data packets to the UE.

### CROSS-REFERENCE TO RELATED APPLICATIONS

This application claims priority to and the benefit of the filing date of provisional U.S. Patent Application No. 63/377,719 entitled “MANAGING DATA COMMUNICATION IN A SERVING CELL CHANGE SCENARIO,” filed on Sep. 29, 2022. The entire contents of the provisional application are hereby expressly incorporated herein by reference.

### FIELD OF THE DISCLOSURE

This disclosure relates to wireless communications and, more particularly, to managing data communication in a serving cell change for a user equipment (UE) and disaggregated base station.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, in some scenarios, the UE and a base station use SRBs to exchange RRC messages as well as non-access stratum (NAS) messages. In further scenarios, the UE and base station use DRBs to transport data on a user plane.

Depending on the scenario, UEs use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN and can be referred to as MCG SRBs. SRB3 resources allow the UE and the SN to exchange RRC messages related to the SN and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE, in some scenarios, concurrently utilizes resources of multiple radio access network (RAN) nodes (e.g., base stations or components of a distributed base station), interconnected by a backhaul. When such network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determine that the UE should establish a radio connection with another base station. For example, one base station determines to hand the UE over to the second base station and initiates a handover procedure.

When the UE moves from coverage area of one cell to another cell in a RAN, at some point a serving cell change will be performed for the UE. To perform the serving cell change, the RAN configures the UE to transmit Layer 3 (L3) measurement results. Based on L3 measurement results received from the UE, the RAN transmits an RRC reconfiguration message configuring Reconfiguration with Synchronization (e.g., the RRC reconfiguration message includes a ReconfigurationWithSync IE) for change of the serving cell (e.g., PCell or PSCell). In cases where the UE operates in carrier aggregation (CA) of at least one secondary cell (SCell) with the PCell or PSCell, the RAN has to release the at least one SCell due to the change of the PCell or PSCell. The serving cell change involves complete L2 (and L1) resets, leading to longer latency, larger overhead, and longer interruption time. Thus, it is desirable to develop new mobility techniques to reduce latency and overhead for fast serving cell change. However, it is not clear how to develop and realize the fast serving cell change.

### SUMMARY

An example embodiment of the techniques of this disclosure is a method in a CU of a distributed base station that includes the CU and a DU, the method comprising: transmitting, to a UE via the DU and in a first cell, a configuration for performing a serving cell change to a second cell subsequent to an activation command; and in response to receiving a DU-to-CU message subsequent to the transmitting of the configuration but prior to receiving an indication that the UE has connected to the second cell, suspending downlink (DL) transmissions of data packets to the UE.

Another example embodiment of these techniques is a method in a DU of a distributed base station that includes the DU and a CU, the method comprising: communicating with a user equipment (UE) in a first cell in accordance with first configuration parameters; transmitting, to the UE, a configuration for performing a serving cell change to a second cell subsequent to an activation command; transmitting, to the UE and in response to a measurement report, the activation command; and in response to the transmitting of the activation command, transmitting, to the CU, an indication to suspend downlink (DL) transmissions of data packets to the UE.

Still another example embodiment of these techniques is a node in a radio access network (RAN) comprising processing hardware and configured to implement one of the methods above.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station including a centralized unit (CU) and a distributed unit (DU) that can operate in the system of FIG. 1A;

FIG. 2 is a block diagram of an example protocol stack according to which the UE of FIG. 1A communicates with base stations; and

FIG. 3 is a messaging diagram of an example scenario where a base station configures a UE to perform a lower layer procedure for a cell change operation;

FIG. 4 is a messaging diagram of an example scenario where a base station configures a UE to perform a lower layer procedure for an inter-DU cell change operation;

FIG. 5A is a messaging diagram of an example scenario where an MN operates in DC with an SN to perform a lower layer procedure for a cell change operation;

FIG. 5B is a messaging diagram of an example scenario similar to that of FIG. 5A, but in which the MN configures the UE directly;

FIG. 6A is a messaging diagram of an example scenario similar to that of FIG. 5A, but in which the cell change operation is an inter-DU cell change operation;

FIG. 6B is a messaging diagram of an example scenario similar to that of FIG. 5B, but in which the cell change operation is an inter-DU cell change operation;

FIG. 7A is a messaging diagram of an example scenario similar to that of FIG. 5A, but in which the base station operates as the MN (e.g., an M-DU) and the SN (e.g., an S-DU) to perform the cell change operation;

FIG. 7B is a messaging diagram of an example scenario similar to that of FIG. 7A, but in which the MN configures the UE directly;

FIG. 8A is a messaging diagram of an example scenario similar to that of FIG. 7A, but in which the cell change operation is an inter-DU cell change operation;

FIG. 8B is a messaging diagram of an example scenario similar to that of FIG. 7B, but in which the cell change operation is an inter-DU cell change operation;

FIG. 9A is a flow diagram depicting an example method, implemented in a DU, in which the DU transmits a configuration for later activation to a UE and transmits a message to a CU to indicate that a cell change is initiated after activating the configuration;

FIG. 9B is a flow diagram depicting an example method similar to that of FIG. 9A, but in which the DU transmits a message to the CU to suspend downlink data transmission after activating the configuration;

FIG. 10A is a flow diagram depicting an example method, implemented in a CU, in which the CU transmits a configuration for later activation to a UE via a DU and receives an indication that a cell change is initiated from the DU;

FIG. 10B is a flow diagram depicting an example method similar to that of FIG. 10A, but in which the CU receives an indication to suspend downlink data transmission from the DU;

FIG. 11 is a flow diagram depicting an example method, implemented in a UE, in which the UE receives a configuration for later activation, receives a configuration activation command, and suspends a radio bearer;

FIG. 12A is a flow diagram depicting an example method, implemented in a CU, in which the CU determines whether to obtain a configuration for the UE from the DU based on whether a second cell (e.g., to be operated on) is operated by a DU connected to the CU; and

FIG. 12B is a flow diagram depicting an example method similar to that of FIG. 12A, but in which the CU makes the determination based on whether the second cell is operated by another base station.

### DETAILED DESCRIPTION OF THE DRAWINGS

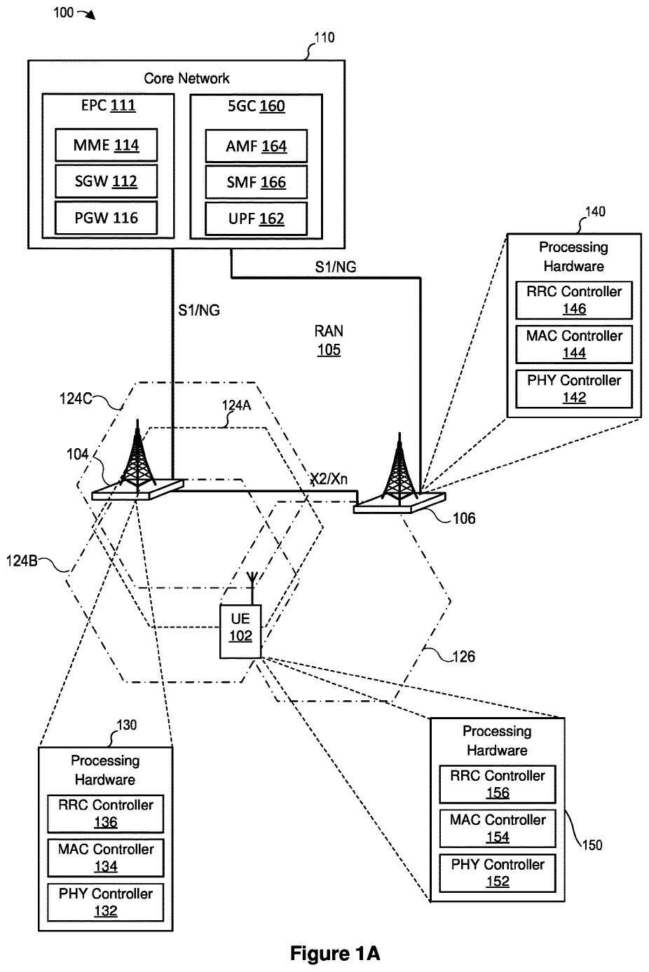

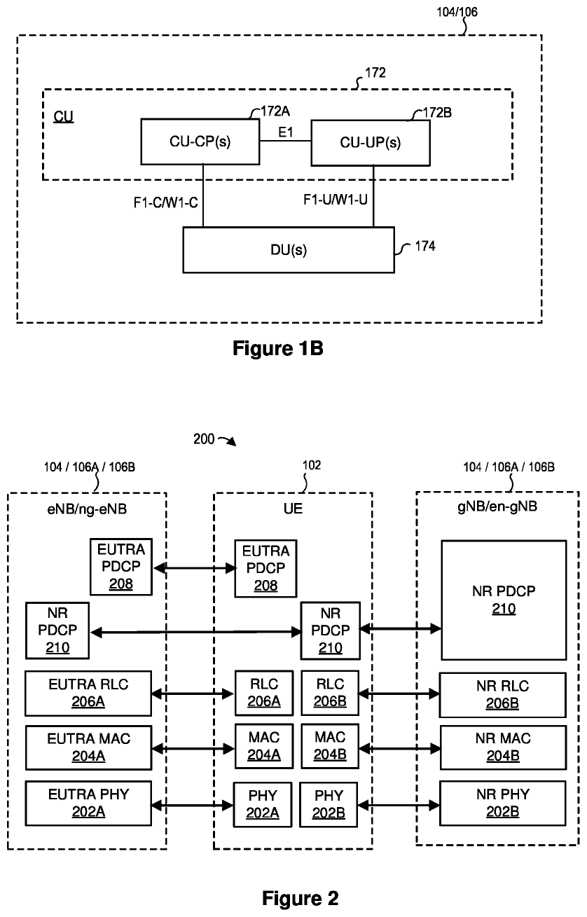

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can partially overlap, so that the UE 102 can communicate in DC with the base station 104 and the base station 106, where one of the base stations 104 and 106 is an MN and the other is an SN. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104. The base station 104 can operate the cells 124A, 124B and 124C via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g. UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

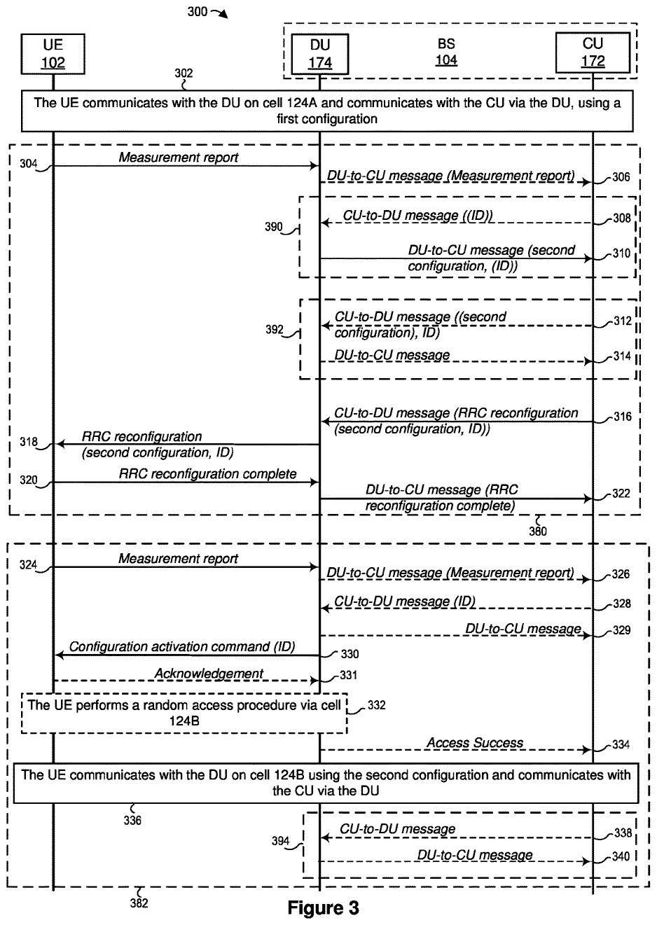

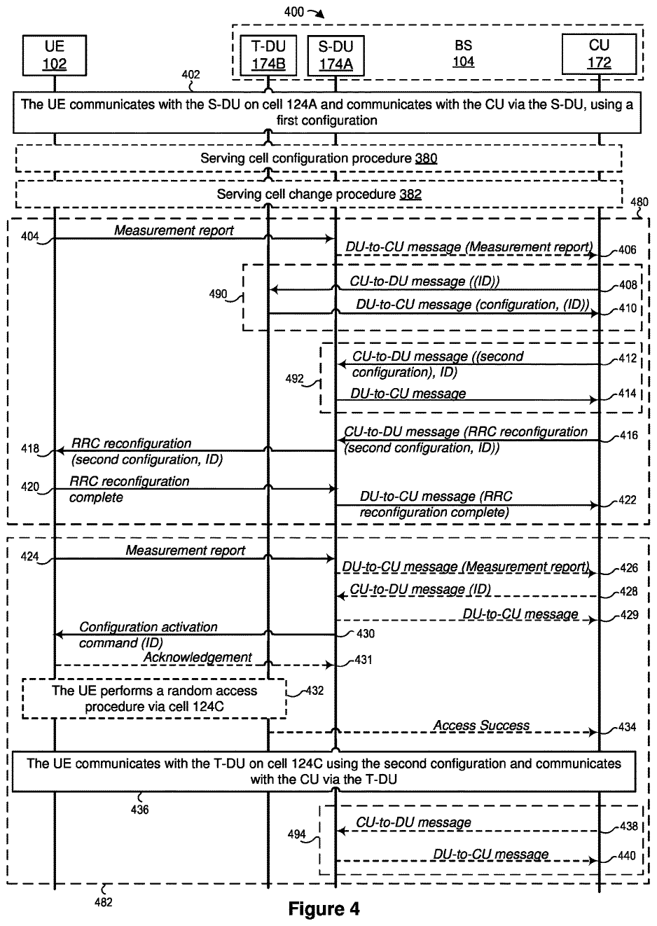

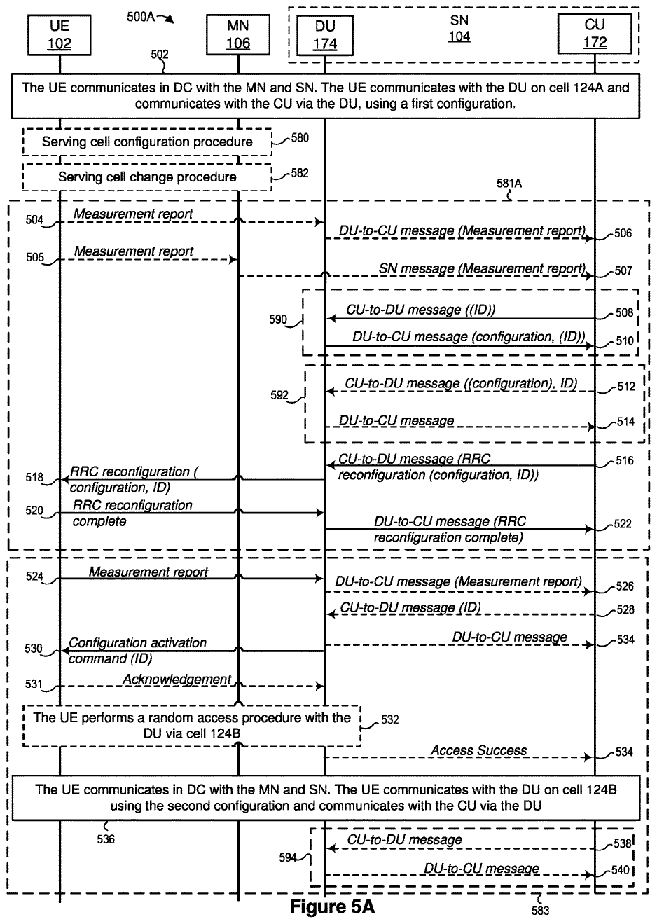

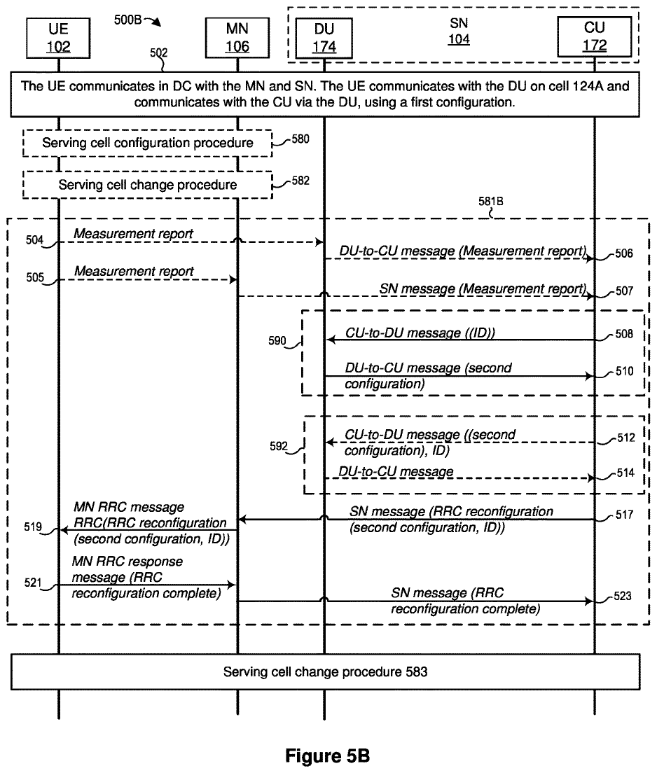

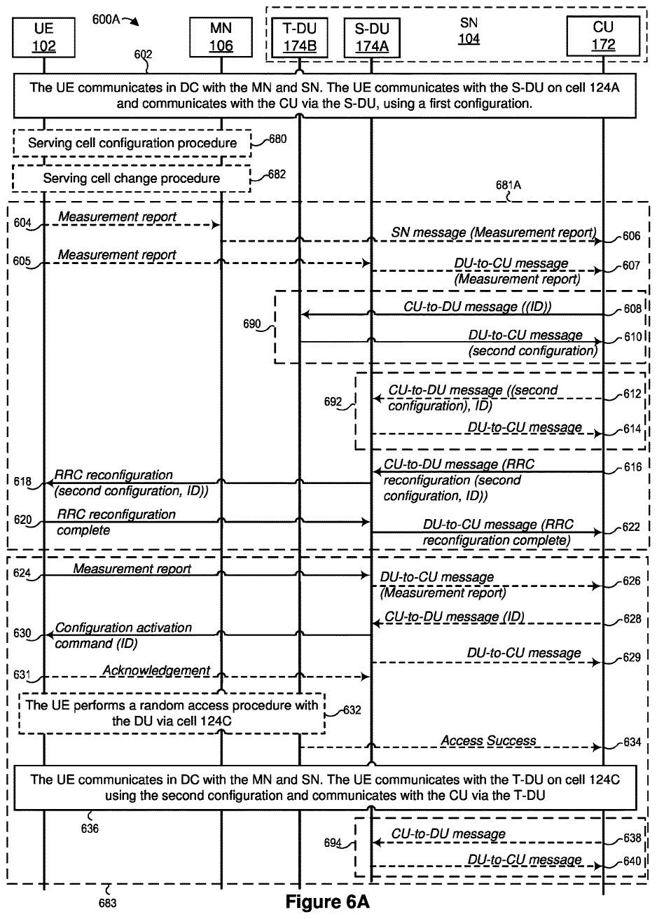

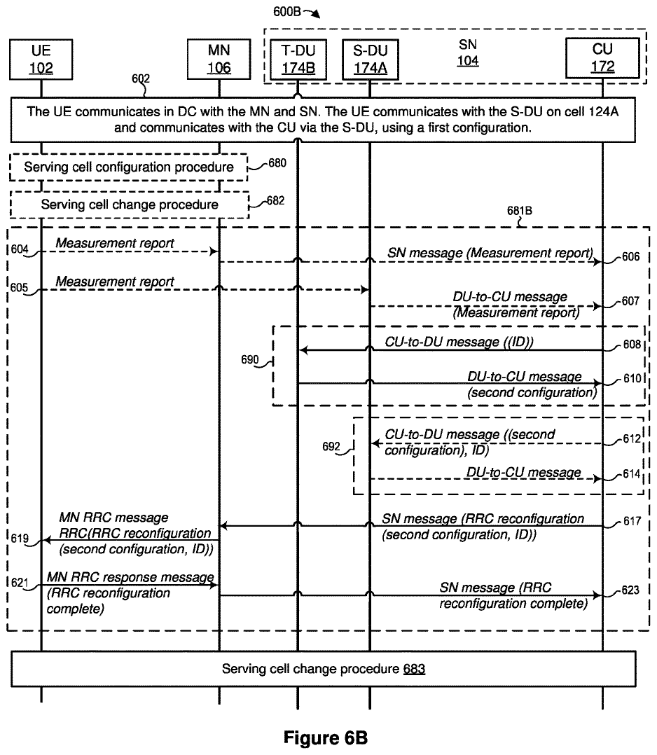

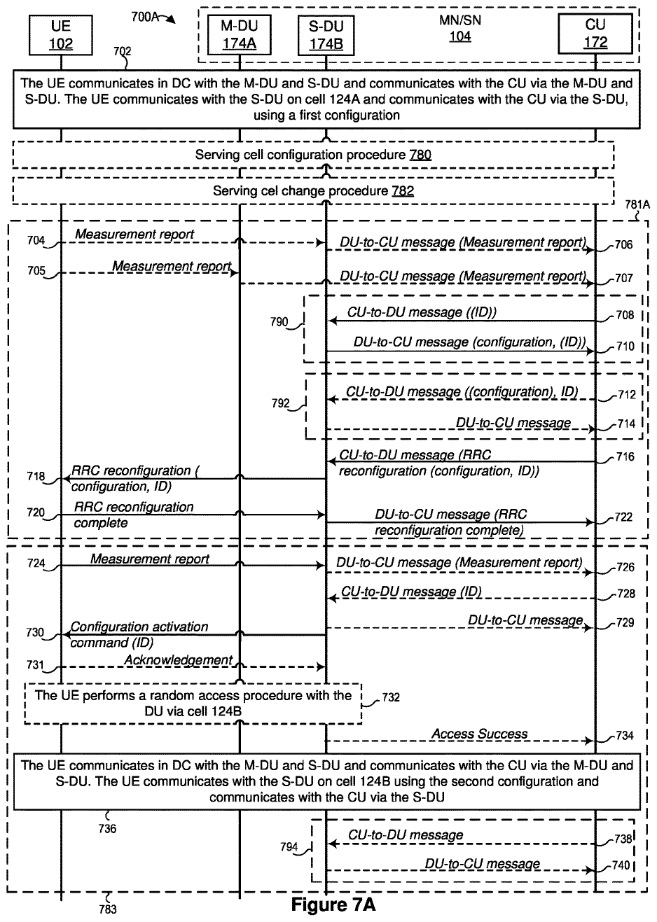

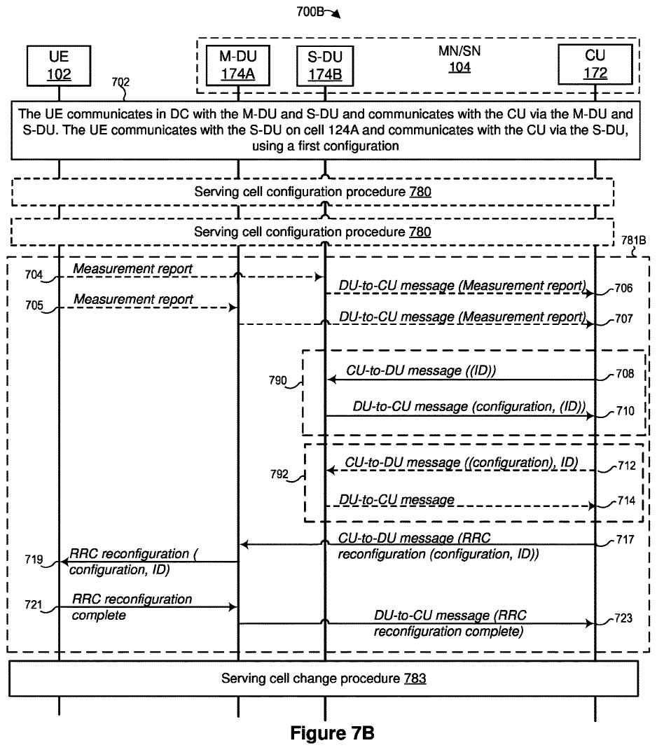

Next, several example scenarios in which the base station operating in the system of FIG. 1A transmits a configuration to the UE 102 and later activates the configuration for communication between the UE 102 and base station. Generally speaking, events in FIGS. 3-7B that are similar are labeled with similar reference numbers (e.g., event 316 is similar to event 416 of FIGS. 4A and 4B, event 516 of FIG. 5A, event 517 of FIG. 5B, event 616 of FIG. 6A, event 617 of FIG. 6B, event 716 of FIG. 7A, and event 717 of FIG. 7B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU 172 and a DU 174 and the DU 174 operates the cell 124A. The UE 102 initially communicates 302 with the base station 104 on cell 124A using a first configuration. In some implementations, the UE 102 in carrier aggregation (CA) communicates with the DU 174 on the cell 124A and other cell(s) (e.g., cell 124D not shown in FIG. 1A) using the first configuration. The DU 174 operates the other cell(s). In other implementations, the UE 102 communicates with the DU 174 on the cell 124A only. In some implementations, the UE 102 communicates with the DU 174 on the cell 124A and/or other cell(s) via one or multiple TRPs. In some implementations, the cell 124A is a PCell. In such cases, the other cell(s) include SCell(s) and/or additional cell(s) associated with the PCell or a SCell. In other implementations, the cell 124A is an SCell, and one of the other cell(s) is a PCell. In such cases, the rest of the cells include SCell(s) and/or additional cell(s) associated with the PCell or a SCell. In the following description, the base station 104 can be the DU 174, the CU 172, or the DU 174 and CU 172.

In some implementations, in the event 302, the UE 102 transmits UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which, in further implementations, include SRBs and/or DRB(s). In some implementations, the base station 104 configures the radio bearers to the UE 102. In some implementations, UL control signals include UL control information, channel state information, hybrid automatic repeat request (HARQ) acknowledgements (ACKs), HARQ negative ACKs, scheduling request(s), and/or sounding reference signal(s). Similarly, in further implementations, the UE 102 receives DL PDUs and/or DL control signals from the base station 104 on the cell 124A and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). In further implementations, the base station 104 transmits the DCIs on physical downlink control channel(s) (PDCCH(s)) monitored by the UE 102, on the cell 124A and/or other cell(s) via one or multiple TRPs.

In some implementations, the first configuration includes physical layer configuration parameters, MAC configuration parameters, RLC configuration parameters, PDCP configuration parameters, measurement configuration parameters, and/or radio bearer configuration parameters. In some implementations, the first configuration includes a CellGroupConfig IE (e.g., defined in 3GPP specification 38.331) or configuration parameters in the CellGroupConfig IE. In some implementations, the first configuration includes a CSI-MeasConfig IE, a MeasConfig IE, and/or a RadioBearerConfig IE (e.g., defined in 3GPP specification 38.331) or includes configuration parameters in the CSI-MeasConfig IE, MeasConfig IE, and/or RadioBearerConfig IE. In some implementations, the UE 102 receives the configuration parameters from the base station 104. In other implementations, the UE 102 receives a portion of the configuration parameters from a base station other than the base station 104 and the remaining portion of the configuration parameters from the base station 104.

While communicating with the base station 104, the UE 102 transmits 304 at least one measurement report to the DU 174. In some implementations, the at least one measurement report includes Layer 1 (L1) measurement report(s) and/or Layer 3 (L3) measurement report(s) for at least one serving cell of the UE 102 and/or at least one non-serving cell. For each of the L3 measurement report(s), the DU 174 transmits 306 a DU-to-CU message, including the L3 measurement report, to the CU 172. In some implementations, the DU-to-CU message(s) of the event 306 are F1 application protocol (F1AP) message(s) (e.g., UL RRC Message Transfer message(s)). In some implementations, the UE 102 does not transmit or refrains from transmitting the L1 measurement report(s) to the CU 172. The at least one serving cell includes the cell 124A and/or other cell(s), and the at least one non-serving cell includes the cell 124B and/or cell 124C. In some implementations, the first configuration includes at least one measurement configuration. In some implementations, the UE 102 receives one or more RRC messages (e.g., RRCReconfiguration message(s)), including the at least one measurement configuration, from the CU 172 via the DU 174 in the event 302. In accordance with the at least one measurement configuration, the UE 102 performs measurements and transmits 304 the at least one measurement report to the DU 174. In some implementations, the at least one measurement configuration includes L3 measurement configuration(s) (e.g., MeasConfig IE(s)) and/or L1 measurement configuration(s). For example, the L1 measurement configuration(s) (e.g., CSI-MeasConfig 1E(s)) includes CSI resource configuration(s) (e.g., CSI-ResourceConfig IE(s)) and/or CSI reporting configuration(s) (e.g., CSI-ReportConfig IE(s)). The UE 102 transmits the L3 measurement report(s) to the CU 172 via the DU 174 in accordance with the L3 measurement configuration(s). The UE 102 transmits the L1 measurement report(s) to the DU 174 in accordance with the L1 measurement configuration(s). In some implementations, the at least one measurement configuration includes new-type measurement configuration(s) (e.g., new RRC IE(s) (e.g., as defined in 3GPP specification 38.331 v18.0.0 and/or later version(s))) for the fast serving cell change. For example, the new-type measurement configuration(s) includes CSI resource configuration(s) (e.g., CSI-ResourceConfig IE(s)) and/or new-type reporting configuration(s). In such implementations, the at least one measurement report includes new-type measurement report(s) associated with the new-type measurement configuration(s). The UE 102 transmits the new-type measurement report(s) to the DU 174 in accordance with the new-type measurement configuration(s). In some implementations, each of the new-type reporting configuration(s) includes a trigger event configuration configuring a trigger event to trigger the UE 102 to transmit a new-type measurement report. If the UE 102 detects the trigger event, the UE 102 transmits a new-type measurement report to the DU 174.

In some implementations, the L1 measurement report(s) include at least one L1 measurement result. In some implementations, the at least one L1 measurement result includes at least one L1-reference signal received power (L1-RSRP) value and/or at least one L1-Signal to Interference Noise Ratio (L1-SINR) value. In some implementations, for each of the L1 measurement report(s), the UE 102 transmits a PUCCH transmission including the L1 measurement report to the DU 174. That is, the UE 102 transmits each of the L1 measurement report(s) on a PUCCH to the DU 174. In other implementations, for each of the L1 measurement report(s), the UE 102 transmits a PUSCH transmission including the L1 measurement report to the DU 174. That is, the UE 102 transmits each of the L1 measurement report(s) on a PUSCH to the DU 174. In yet other implementations, the UE 102 transmits a portion of the L1 measurement report(s) on PUCCH(s) and the rest of the L1 measurement report(s) on physical UL shared channel(s) (PUSCH(s)) to the DU 174. That is, for each of the portion of the L1 measurement report(s), the UE 102 transmits a PUCCH transmission including the L1 measurement report to the DU 174, and for each of the rest of the L1 measurement report(s), the UE 102 transmits a PUSCH transmission including the L1 measurement report to the DU 174. In some implementations, each of the L1 measurement report(s) is a part of channel state information (CSI) (i.e., a CSI component) or CSI. In some implementations, the UE 102 includes other CSI component(s) in the PUCCH transmission(s) and/or PUSCH transmission(s) described above. In some implementations, the other CSI component(s) include such components as a channel quality indicator (CQI), a Precoding Matrix Indicator (PMI), a CSI-RS Resource Indicator (CRI), a Synchronization Signal (SS)/Physical Broadcast Channel (PBCH) Resource Block Indicator (SSBRI), a Layer Indicator (LI), and/or a Rank Indicator (RI).

In some implementations, each of the L3 measurement report(s) includes at least one L3 measurement result. In some implementations, the at least one L3 measurement result includes at least one RSRP value and/or at least one SINR value. In some implementations, the UE 102 transmits each of the L3 measurement report(s) on a PUSCH to the CU 172 via the DU 174. In some implementations, each of the L3 measurement report(s) is an RRC message (e.g., MeasurementReport message). In some implementations, each of the L3 measurement configuration(s) includes a particular measurement identity (e.g., measId), and each of the L3 measurement report(s) includes a particular measurement identity in a particular L3 measurement configuration. In some implementations, when the CU 172 receives an L3 measurement report, including a measurement identity and an L3 measurement result, from the UE 102 via the DU 174, the CU 172 determines that the L3 measurement report is associated with an L3 measurement configuration identified by the measurement identity.

In some alternative implementations, for each of the at least one measurement report (e.g., L1 measurement report(s) and/or new-type measurement report(s)), the UE 102 transmits a MAC control element (CE), including the measurement report, to the DU 174 in the event 304. To transmit the MAC CE(s), the UE 102 generates one or more MAC PDUs, each including one or more of the MAC CE(s), to the DU 174 in the event 304.

In some implementations, the UE 102 performs measurements on one or more reference signals in accordance with the at least one measurement configuration. In further implementations, the one or more reference signals include one or more Synchronization Signal (SS)/Physical Broadcast Channel (PBCH) Resource Blocks (SSBs) and/or one or more CSI-RSs. The UE 102 obtains the at least one L1 measurement result and/or at least one L3 measurement result from the measurements. The DU 174 transmits the one or more reference signals on the cells 124A and 124B, and optionally the cell 124C and/or other cell(s).

After (e.g., in response to) receiving one or more of the at least one measurement report from the UE 102, the base station 104 (i.e., the CU 172 or DU 174) determines to prepare the cell 124B for the UE 102. In some implementations, the base station 104 determines to prepare the cell 124B for the UE 102 because the at least one measurement report indicates that the cell 124B could be used by the base station 104 to communicate with the UE 102. In some implementations, the base station 104 determines to prepare the cell 124B for the UE 102 because the at least one measurement report indicates that the cell 124B qualifies to be used for communication with the UE 102. In some implementations, if the L3 measurement report(s) indicates that signal strength and/or quality of the cell 124B is above a first predetermined threshold and/or is better than the cell 124A, the CU 172 determines to prepare the cell 124B for the UE 102. In other implementations, if the L1 measurement report(s) or new-type measurement report(s) indicate that signal strength and/or quality of the cell 124B is above a first predetermined threshold and/or is better (e.g., higher) than the cell 124A, the DU 174 determines to prepare the cell 124B for the UE 102. Alternatively, the base station 104 determines to prepare the cell 124B for the UE 102 regardless of whether a measurement report is received from the UE 102 or not.

In some implementations, if the CU 172 determines to prepare the cell 124B, the CU 172 transmits 308 a first CU-to-DU message to the DU 174 to prepare the cell 124B for the UE 102. In some implementations, the CU 172 includes a cell identity (ID) of the cell 124B in the first CU-to-DU message. For example, the cell ID is cell global identity (CGI). In another example, the cell ID is a physical cell ID (PCI). In response, the DU 174 generates a second configuration (referred to herein as configuration 1) configuring the cell 124B and transmits 310 a first DU-to-CU message, including the second configuration, to the CU 172. In further implementations, if the DU 174 determines to prepare the cell 124B, the DU 174 initiates transmission of the first DU-to-CU message to the CU 172.

After receiving first DU-to-CU message, the CU 172 generates an RRC reconfiguration message (e.g., an RRCReconfiguration message), including the configuration 1, and transmits 316 a second CU-to-DU message, including the RRC reconfiguration message, to the DU 174. In turn, the DU 174 transmits 318 the RRC reconfiguration message to the UE 102. In response, the UE 102 transmits 320 an RRC reconfiguration complete message (e.g., an RRCReconfigurationComplete message) to the DU 174, which in turn transmits 322 a second DU-to-CU message including the RRC reconfiguration complete message to the CU 172. In some implementations, the CU 172 performs security protection (e.g., integrity protection and/or encryption) on the RRC reconfiguration message. For example, the CU 172 generates a message authentication code for integrity (MAC-I) for the RRC reconfiguration message, encrypts the RRC reconfiguration message and the MAC-I to obtain an encrypted RRC reconfiguration message and an encrypted MAC-I, and transmits a PDCP PDU, including the encrypted RRC reconfiguration message and encrypted MAC-I, to the UE 102 via the DU 174 in the events 316 and 318. When the UE 102 receives the PDCP PDU from the CU 172 via the DU 174 (i.e., events 316 and 318), the UE 102 decrypts the encrypted RRC reconfiguration and encrypted MAC-I to obtain the RRC reconfiguration message and MAC-I and verifies whether the MAC-I is valid. If the UE 102 verifies that the MAC-I is invalid, the UE 102 discards or ignores the RRC reconfiguration message. In some implementations, the UE 102 performs an RRC connection reestablishment procedure in response to the invalid MAC-I. Otherwise, in further implementations, if the UE 102 verifies that the MAC-I is valid, the UE 102 processes the RRC reconfiguration. The UE 102 refrains from applying (i.e., executing) the configuration 1 until receiving a configuration activation command activating the configuration 1 (e.g., the event 330).

In some implementations, the first CU-to-DU message is a UE Context Modification Request message, and the first DU-to-CU message is a UE Context Modification Response message or UE Context Modification Required message. In some implementations, in the case of the UE Context Modification Required message, the CU 172 transmits a UE Context Modification Confirm message to the DU 174 in response to the UE Context Modification Required message. In some implementations, the second CU-to-DU message is a DL RRC Message Transfer message. In other implementations, the second CU-to-DU message is a UE Context Modification Request message, and the DU 174 transmits a second DU-to-CU message (e.g., UE Context Modification Response message) to the CU 172 in response to the second CU-to-DU message.

The events 308 and 310 are collectively referred to in FIG. 3 as a serving cell preparation procedure 390.

In some implementations, the CU 172 includes a field or an IE in the RRC reconfiguration message of the events 316 and 318 to indicate to the UE 102 not to apply the configuration 1 immediately. In some implementations, the field or IE is currently defined (e.g., in 3GPP specification 38.331 v18.0.0 and/or later versions). In further implementations, the field or IE is newly defined (e.g., in a 3GPP 6G specification). In some implementations, the field or IE is an indicator. If the RRC reconfiguration message of the event 318 includes the indicator, the UE 102 refrains from immediately applying the configuration 1. Otherwise, if the RRC reconfiguration message of the event 318 does not include the indicator, the UE 102 applies the configuration 1 immediately. In other implementations, the field or IE is a container (e.g., the first container and/or second container described below). For example, the UE 102 receives an RRC reconfiguration message (e.g., the RRC reconfiguration message of the event 318) including a configuration (e.g., configuration 1). If the configuration is included in the container, the UE 102 refrains from immediately applying the configuration. Otherwise, if the configuration is not included in the container, the UE 102 applies the configuration immediately.

In some implementations, after receiving the configuration 1 in the event 310, the CU 172 generates a first container including the configuration 1, includes the first container in the RRC reconfiguration message, and transmits the RRC reconfiguration message to the UE 102 in the event 316. Alternatively, the DU 174 generates the first container and includes the first container in the first DU-to-CU message. In some implementations, the first container is a first addition or modification list (e.g., ConfigToAddModList IE, CellConfigToAddModList IE, MobilityToAddModList IE, MobilityConfigToAddModList IE, or CellGroupConfigToAddModList IE). The base station 104 includes the configuration 1 in a first element (referred to herein as element 1) of the first addition or modification list. For example, the element 1 is an addition or modification IE (e.g., ConfigToAddMod IE, CellConfigToAddMod IE, MobilityToAddMod IE, MobilityConfigToAddMod IE, or CellGroupConfigToAddMod IE). In some implementations, when the UE 102 receives the first addition or modification list, the UE 102 stores the first addition or modification list (e.g., in a variable in the random access memory (RAM)).

In some implementations, the CU 172 includes, in the RRC reconfiguration message, a first ID (referred to herein as ID 1) for identifying the configuration 1. In some implementations, the CU 172 includes the ID 1 in the first container or element 1. In some implementations, the CU 172 assigns the ID 1 for the configuration 1. In other implementations, the CU 172 receives the ID 1 from the DU 174 in the first DU-to-CU message, as described below.

In some implementations, the CU 172 transmits the ID 1 to the DU 174, so that the DU 174 can associate the ID 1 with the configuration 1. In some implementations, the CU 172 includes the ID 1 in the first CU-to-DU message. In further implementations, the CU 172 transmits 312 a third CU-to-DU message including the ID 1 to the DU 174. In some such cases, the CU 172 includes the configuration 1 in the third CU-to-DU message to indicate the association between the ID 1 and configuration 1. In further implementations, the DU 174 transmits 314 a third DU-to-CU message to the CU 172 in response to the third CU-to-DU message. The events 312 and 314 are collectively referred to in FIG. 3 as an ID allocation procedure 392.

In some implementations, in cases where the CU 172 includes the ID 1 in the first CU-to-DU message, the DU 174 includes the ID 1 in the configuration 1. In such cases, the CU 172 does not include the ID 1 in the RRC reconfiguration message, first container, and/or element 1.

In some alternative implementations, the DU 174 assigns the ID 1 for identifying the configuration 1. In some implementations, the DU 174 includes the ID 1 in the first DU-to-CU message. In further implementation, the CU 172 includes the ID 1 in the RRC reconfiguration message. In other implementations, the DU 174 includes the ID 1 in the configuration 1. Thus, the CU 172 does not include an ID identifying the configuration 1 in the RRC reconfiguration message, first container, and/or element 1.

In some implementations, the configuration 1 includes a plurality of configurations for the UE 102 to communicate with the DU 174 on the cell 124B. In some implementations, the plurality of configurations include physical layer configuration parameters (e.g., PhysicalCellGroupConfig IE), MAC layer configuration parameters (e.g., MAC-CellGroupConfig IE), and/or RLC configuration parameters (e.g., RLC-BearerConfig IE(s)). In some further implementations, the plurality of configurations includes a special cell configuration (e.g., SpCellConfig IE) and/or one or more SCell configurations (e.g., SCellConfig IE(s)).

In some implementations, the DU 174 includes a random access configuration in the configuration 1. In other implementations, the DU 174 does not include a random access configuration in the configuration 1. In some implementations, if the cell 124A and cell 124B are not synchronized, the DU 174 determines to include the random access configuration in the configuration 1. Otherwise, if the cell 124A and cell 124B are synchronized, the DU 174 determines to not include the random access configuration in the configuration 1. In other implementations, if the DU 174 determines that the UE 102 has not synchronized in UL with the cell 124B, the DU 174 determines to include the random access configuration in the configuration 1. Otherwise, if the DU 174 determines that the UE 102 has synchronized in UL with the cell 124B, the DU 174 determines to not include the random access configuration in the configuration 1. If the configuration 1 includes the random access configuration, the UE 102 performs the random access procedure in the event 332 in accordance with the random access configuration, as described below. Otherwise, if the configuration 1 does not include the random access configuration, the UE 102 skips the random access procedure of the event 332 in response to the configuration 1 excluding the random access configuration.

In some implementations, the DU 174 includes a random access configuration in the configuration 1 regardless of whether the cells 124A and 124B are synchronized or not. In some implementations, if the cell 124A and cell 124B are synchronized, the DU 174 determines to include, in the configuration 1, a first indication configuring the UE 102 not to perform a random access procedure on the cell 124B. Otherwise, if the cell 124A and cell 124B are not synchronized, the DU 174 determines to not include the first indication in the configuration 1. In other implementations, if the DU 174 determines that the UE 102 has synchronized in UL with the cell 124B, the DU 174 determines to include the first indication in the configuration 1. Otherwise, if the DU 174 determines that the UE 102 has not synchronized in UL with the cell 124B, the DU 174 determines to not include the first indication in the configuration 1. If the configuration 1 includes the first indication, the UE 102 skips the random access procedure of the event 332 in accordance with or in response to the first indication. Otherwise, if the configuration 1 does not include the first indication, the UE 102 performs the random access procedure in accordance with the random access procedure in the event 332, in response to the configuration 1 excluding the first indication, as described below.

In some implementations, the DU 174 includes a reconfiguration with sync configuration (e.g., ReconfigurationWithSync IE) in the configuration 1 or special cell configuration. In other implementations, the DU 174 does not include a reconfiguration with sync configuration (e.g., ReconfigurationWithSync IE) in the configuration 1 or special cell configuration. In some implementations, if the cell 124A and cell 124B are not synchronized, the base station 104 determines to include the reconfiguration with sync configuration in the configuration 1. Otherwise, if the cell 124A and cell 124B are synchronized, the DU 174 determines to not include the reconfiguration with sync configuration in the configuration 1. In other implementations, if the DU 174 determines that the UE 102 has not synchronized in UL with the cell 124B, the DU 174 determines to include the reconfiguration with sync configuration in the configuration 1. Otherwise, if the DU 174 determines that the UE 102 has synchronized in UL with the cell 124B, the DU 174 determines to not include the reconfiguration with sync configuration in the configuration 1. In some implementations, if the configuration 1 includes the reconfiguration with sync configuration, the UE 102 performs the random access procedure in the event 332 as described below, in response to or in accordance with the reconfiguration with sync configuration. Otherwise, if the configuration 1 does not include the reconfiguration with sync configuration, the UE 102 skips the random access procedure of the event 332. In some implementations, the DU 174 includes a cell ID (i.e., cell ID 1) of cell 1 (i.e., the cell 124B) in the configuration 1. In some implementations, the cell ID 1 is a PCI. In further implementations, the cell ID 1 is a CGI. In some further implementations, the configuration 1 includes a cell index 1 (e.g., a serving cell index) indexing the cell ID 1 or the cell 124B.

In some implementations, after (e.g., in response to) receiving one or more of the at least one measurement report of the event 304, the base station 104 (i.e., the CU 172 or DU 174) determines to prepare other cell(s) of the base station 104 for the UE 102. In some implementations, the base station 104 determines to prepare the other cell(s) because the at least one measurement report indicates that the other cell(s) could be used by the base station 104 to communicate with the UE 102. In further implementations, the other cell(s) include the cell 124C and/or cell(s) other than the cells 124A, 124B, and 124C. In some implementations, if the L3 measurement report(s) indicate that signal strength and/or quality of a particular cell of the other cell(s) is above a respective predetermined threshold and/or is better (e.g., higher) than the cell 124A, the CU 172 determines to prepare the particular cell for the UE 102. In other implementations, if the L1 measurement report(s) or new-type measurement report(s) indicate that signal strength and/or quality of a particular cell of the other cell(s) is above a first predetermined threshold and/or is better (e.g., higher) than the cell 124A, the DU 174 determines to prepare the particular cell for the UE 102. In some implementations, the respective predetermined threshold(s) for the other cells are different from the first predetermined threshold. In further implementations, the respective predetermined threshold(s) for the other cell(s) are the same as the first predetermined threshold. In some implementations, the respective predetermined thresholds for the other cells are the same or different. Alternatively, the base station 104 determines to prepare the other cell(s) for the UE 102 regardless of whether a measurement report is received from the UE 102 or not.

In some implementations, in response to the determination regarding preparing the other cell(s), the CU 172 and DU 174 perform at least one other serving cell preparation procedure to prepare the other cell(s), where each of the at least one other serving cell preparation procedure is similar to the procedure 390. In some implementations, the CU 172 includes cell ID(s) of the other cell(s) in at least one CU-to-DU message of the at least one serving cell preparation procedure, similar to the first CU-to-DU message. In some implementations, the CU 172 and DU 174 perform an additional serving cell preparation procedure to prepare each of the other cell(s), similar to the procedure 390. In some such cases, the CU 172 includes a cell ID of a particular cell of the other cell(s) in a CU-to-DU message of the serving cell preparation procedure, similar to the first CU-to-DU message. In the serving cell preparation procedure(s), the DU 174 generates configuration(s) 2, . . . , N, each configuring a particular cell of the other cell(s), and transmits the configuration(s) 2, . . . , N to the CU 172, as described for the configuration 1. “N” is an integer and larger than one. For example, “N” is 2, 4, 6, 8, 10, 12, 14 or 16. Examples and implementations of the configuration 1 can apply to the configuration(s) 2, . . . , N.

In other implementations, the CU 172 determines to prepare the other cell(s) in the procedure 390. In some such cases, the CU 172 includes a cell ID for each of the other cell(s) in the first CU-to-DU message, and the DU 174 includes the configuration(s) 2, . . . , N in the first DU-to-CU message. In yet other implementations, the DU 174 determines to prepare the other cell(s) in the procedure 390 and includes the configuration(s) 2, . . . , N in the first DU-to-CU message.

In some implementations, after receiving the configuration(s) 2, . . . , N from the DU 174, the CU 172 includes the configuration(s) 2, . . . , N in the first container. In some implementations, the CU 172 includes the configuration(s) 2, . . . , N in element(s) 2, . . . , N and includes the element(s) 2, . . . , N in the first container. In some implementations, the CU 172 includes, in the RRC reconfiguration message, ID(s) 2, . . . , N for identifying the configuration(s) 2, . . . , N, respectively. In some implementations, the CU 172 includes the ID(s) 2, . . . , N in the first container. For example, the CU 172 includes the ID(s) 2, . . . , N and configuration(s) 2, . . . , N in the element(s) 2, . . . , N in the first addition or modification list.

In some implementations, the CU 172 assigns the ID(s) 2, . . . , N for the configuration(s), . . . , N. In other implementations, the CU 172 receives the ID(s) 2, . . . , N from the DU 174 in the first DU-to-CU message of the procedure 390 or in DU-to-CU message(s) of the at least one other serving cell preparation procedure or additional serving cell preparation procedure(s).

In some implementations, the CU 172 performs an ID allocation procedure with the DU 174 for each of the configuration(s) 2, . . . , N, similar to the procedure 392. In such cases, the DU 174 includes the ID(s) 2, . . . , N in the configuration(s) 2, . . . , N. In such cases, the CU 172 does not include the ID(s) 2, . . . , N in the RRC reconfiguration message, first container and/or element(s) 2, . . . , N.

In some alternative implementations, the DU 174 assigns the ID(s) 2, . . . , N in the configuration(s) 2, . . . , N. In some implementations, the DU 174 includes the ID(s) 2, . . . , N in the first DU-to-CU message of the procedure 390 or in DU-to-CU message(s) of the at least one other serving cell preparation procedure or additional serving cell preparation procedure(s). In further implementations, the CU 172 includes the ID(s) 2, . . . , M in the RRC reconfiguration message. In other implementations, the DU 174 includes the ID(s) 2, . . . , N in the configuration(s) 2, . . . , N. Thus, the CU 172 does not include an ID identifying each of configuration(s) 2, . . . , N in the RRC reconfiguration message, first container, and/or element 1.

In some alternative implementations, the CU 172 generates a second container including the configuration(s) 2, . . . , N or element(s) 2, . . . , N instead of using the first container. Alternatively, the DU 174 generates the second container and includes the second container in the first DU-to-CU message or a DU-to-CU message of the other serving cell preparation procedure. The CU 172 then transmits an additional RRC reconfiguration message, including the second container, to the UE 102 via the DU 174, similar to the events 316 and 318. In response, the UE 102 transmits an additional RRC reconfiguration complete message to the CU 172 via the DU 174, similar to the events 320 and 322. In some implementations, the second container is a second addition or modification list (e.g., ConfigToAddModList IE, CellConfigToAddModList IE, MobilityToAddModList IE, MobilityConfigToAddModList IE, or CellGroupConfigToAddModList IE), and each of the element(s) 2, . . . , N is, in further implementations, an addition or modification IE (e.g., ConfigToAddMod IE, ReconfigToAddMod IE, CellConfigToAddMod IE, MobilityToAddMod IE, MobilityConfigToAddMod IE, or CellGroupConfigToAddMod IE). In some implementations, when the UE 102 receives the second addition or modification list, the UE 102 stores the second addition or modification list together with the first addition or modification list (e.g., in a variable in the RAM).

In some implementations, the DU 174 includes cell ID(s) 2, . . . , N in the configuration(s) 2, . . . , N, respectively. The cell ID(s) 2, . . . , N identify cell(s) 2, . . . , N, respectively. In some implementations, each of the cell ID(s) 2, . . . , N is a PCI. In some further implementations, the configuration(s) 2, . . . , N includes cell index(es) 2, . . . , N (e.g., serving cell index(es)) indexing the cell ID(s) 2, . . . , N or the cell(s) 2, . . . , N, respectively.

In some implementations, each of the configuration(s) 1 and/or 2, . . . , N is a CellGroupConfig IE. In such implementations, the following are example structures of the first or second addition or modification list (e.g., CellGroupConfigToAddModList IE), and CellGroupConfigToAddMod IE is an element of the first or second addition or modification list.

In some implementations, the CU 172 transmits, to the UE 102, a release list to release one or more configurations of the configuration(s) 1, . . . , N via the DU 174. For example, the CU 172 transmits an RRC reconfiguration message, including the release list, to the UE 102 via the DU 174. In response, the UE 102 transmits an RRC reconfiguration complete message to the CU 172 via the DU 174. In some implementations, the base station 104 includes ID(s) of the one or more configurations in the release list to indicate the one or more of the configurations to be released. The UE 102 identifies the one or more of the configurations in accordance with the ID(s) and releases the one or more of the configurations in response to the release list.

In some implementations, the base station 104 transmits, to the UE 102, a third addition or modification list, which is empty or does not include a configuration, to release all of the configuration(s) 1, . . . , N. In some implementations, the base station 104 transmits an RRC reconfiguration message, including the third addition or modification list, to the UE 102. In response, the UE 102 transmits an RRC reconfiguration complete message to the CU 172 via the DU 174. The UE 102 releases all of the configuration(s) 1, . . . , N in response to the third addition or modification list.

In some implementations, the CU 172 determines to release the one, some, or all of the configuration(s) 1, . . . , N, and, in further implementations, transmits a CU-to-DU message to the DU 174 to indicate to the DU 174 to release the one, some, or all of the configuration(s) 1, . . . , N. For example, the CU 172 includes one, some, or all of the ID(s) 1, . . . , N in the CU-to-DU message to indicate to the DU 174 to release the one, some, or all of the configuration(s) 1, . . . , N. Depending on the implementation, each of the cell ID(s) 1, . . . , N is a CGI or PCI. In response, the DU 174 releases the one, some, or all of configuration(s) 1, . . . , N, and, in some implementations, transmits a DU-to-CU message to the CU 172. In other implementations, the DU 174 determines to release one, some, or all of the configuration(s) 1, . . . , N, and transmits a DU-to-CU message, including ID(s) of the one, some, or all of the configuration(s) 1, . . . , N to the CU 172. After (e.g., in response to) receiving the DU-to-CU message, the CU 172 generates the release list or the third addition or modification list to release the one, some, or all of the configuration(s) 1, . . . , N.

In yet other implementations, the DU 174 generates the release list or the third addition or modification list. In some such cases, the DU 174 transmits a DU-to-CU message, including the release list or the third addition or modification list, to the CU 172. In further implementations, the CU 172 transmits a CU-to-DU message to the DU 174 in response. In some implementations the DU 174 determines to release the one, some, or all of the configuration(s) 1, . . . , N. In other implementations, the DU 174 receives, from the CU 172, a CU-to-DU message, including the ID(s) of the one, some, or all of the configuration(s) 1, . . . , N to indicate to release the one, some, or all of the configuration(s) 1, . . . , N.

### Example Implementation 1

CellGroupConfigToAddModList ::= SEQUENCE (SIZE (1..
maxNrofConfigCells)) OF CellGroupConfigToAddMod

| | |
|---|---|
| CellGroupConfigToAddMod ::= | SEQUENCE { |
| configId | ConfigId, |
| cellGroupConfig | OCTET STRING (CONTAINING |
| CellGroupConfig) | OPTIONAL, |

...
}
CellGroupConfigToReleaseList ::= SEQUENCE (SIZE (1..
maxNrofConfigCells)) OF ConfigId
maxNrofConfigCells ::= 8

For example, the first addition or modification list is a first CellGroupConfigToAddModList IE, and the second addition or modification list is a second CellGroupConfigToAddModList IE. The element 1 is a CellGroupConfigToAddMod IE 1, and the element(s) 2, . . . , N is/are CellGroupConfigToAddMod IE(s) 2, . . . , N, respectively. The ID 1 and configuration 1 are a ConfigId and a CellGroupConfig IE in the CellGroupConfigToAddMod IE 1, respectively. The ID(s) 2, . . . , N and configuration(s) 2, . . . , N are a ConfigId and a CellGroupConfig IE in the CellGroupConfigToAddMod IE(s) 2, . . . , N, respectively. In some implementations, the first CellGroupConfigToAddModList IE includes the CellGroupConfigToAddMod IE 1, and the second CellGroupConfigToAddModList IE includes the CellGroupConfigToAddMod IE(s) 2, . . . , N. In further implementations, the first CellGroupConfigToAddModList IE includes the CellGroupConfigToAddMod IE(s) 1, . . . , N.

In some implementations, the release list is a CellGroupConfigToReleaseList IE. In further implementations, the base station 104 includes one or more ConfigID IEs in the CellGroupConfigToReleaseList IE to release one or more CellGroupConfigToAddMod IEs of the CellGroupConfigToAddMod IE(s) 1, . . . , N. The one or more CellGroupConfigToAddMod IEs are identified by the one or more ConfigID IEs.

### Example Implementation 2

Example Implementation 2 is similar to Example Implementation 1, except that the CellGroupConfigToAddMod IE does not include a ConfigId.

CellGroupConfigToAddModList ::= SEQUENCE (SIZE (0..
maxNrofConfigCells)) OF CellGroupConfigToAddMod

| | |
|---|---|
| CellGroupConfigToAddMod ::= | SEQUENCE { |
| cellGroupConfig | OCTET STRING (CONTAINING |
| CellGroupConfig) | OPTIONAL, |

...
}
maxNrofConfigCells ::= 8

In some implementations, the ID(s) 1, . . . , N are implicitly indicated by the order of the CellGroupConfigToAddMod IE(s) 1, . . . , N in the first or second CellGroupConfigToAddModList. For example, the CellGroupConfigToAddMod IE 1 is the first IE in the first CellGroupConfigToAddModList IE, which implicitly indicates that the ID 1 has value X. X can be zero or one. If the first CellGroupConfigToAddModList IE includes the CellGroupConfigToAddMod IE(s) 1, . . . , N in sequence, the ID(s) 1, . . . , N have values X, X+1, . . . , X+ (N−1). In some implementations, if the base station 104 transmits the second CellGroupConfigToAddModList IE to the UE 102, the UE 102 and base station 104 replace the first CellGroupConfigToAddModList IE with the second CellGroupConfigToAddModList IE. If the second CellGroupConfigToAddModList IE includes the CellGroupConfigToAddMod IE(s) 2, . . . , N in sequence, the ID(s) 2, . . . , N are values X, X+1, . . . , X+N−2. If the second CellGroupConfigToAddModList IE includes the CellGroupConfigToAddMod IE(s) 1, . . . , N in sequence, the ID(s) 1, . . . , N are values X, X+1, . . . , X+N−1. In some alternative implementations, the ID(s) 1, . . . , N are the cell ID(s) 1, . . . , N.

In some implementations, the base station 104 transmits a CellGroupConfigToAddModList IE including zero CellGroupConfigToAddMod IE to release all of the CellGroupConfigToAddMod IE(s) 1, . . . , N.

In the Example Implementations 1 and 2, the “CellGroupConfigToAddModList”, “CellGroupConfigToAddMod”, “configId”, “ConfigId” “cellGroupConfig”, “CellGroupConfigToReleaseList”, and “maxNrofConfigCells” are exemplary only and should not be considered to restrict scope and application of the invention.

In other implementations, each of the configuration(s) 1 and/or 2, . . . , N is an RRCReconfiguration message. In such implementations, the following (i.e., Example Implementations 3-6) are example structures of the first or second addition or modification list.

### Example Implementation 3

In Example Implementation 3, the first or second addition or modification list is a CondReconfigToAddModList-r16 IE (e.g., as defined in 3GPP specification 38.331 from Release 16), and a CondReconfigToAddMod IE is an element of the list.

CondReconfigToAddModList-r16 ::= SEQUENCE (SIZE (1..
maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF |
| MeasId | OPTIONAL, -- Need M |
| condRRCReconfig-r16 | OCTET STRING (CONTAINING |
| RRCReconfiguration) | OPTIONAL, -- Cond condReconfigAdd |

```
  ...,
  [[
```

| | |
|---|---|
| condExecutionCondSCG-r17 | OCTET STRING (CONTAINING |
| CondReconfigExecCondSCG-r17) | OPTIONAL -- Need M |

]]
}

| | |
|---|---|
| CondReconfigExecCondSCG-r17 ::= | SEQUENCE (SIZE (1..2)) OF MeasId |
| CondReconfigToRemoveList-r16 ::= | SEQUENCE (SIZE (1.. |

maxNrofCondCells-r16)) OF CondReconfigId-r16

For example, the first addition or modification list is a first CondReconfigToAddModList-r16 IE and a second CondReconfigToAddModList-r16 IE. The element 1 is a CondReconfigToAddMod-r16 IE 1, and the element(s) 2, . . . , N are CondReconfigToAddMod-r16 IE(s) 2, . . . , N, respectively. The ID 1 and configuration 1 are a CondReconfigId and an RRCReconfiguration message in the CondReconfigToAddMod IE 1, respectively. The ID(s) 2, . . . , N and configuration(s) 2, . . . , N are a CondReconfigId and an RRCReconfiguration message in the CondReconfigToAddMod IE(s) 2, . . . , N, respectively. In some implementations, the first CondReconfigToAddModList-r16 IE includes the CondReconfigToAddMod-r16 IE 1, and the second CondReconfigToAddModList-r16 IE includes the CondReconfigToAddMod-r16 IE(s) 2, . . . , N. In further implementations, the first CondReconfigToAddModList-r16 IE includes the CondReconfigToAddMod-r16 IE(s) 1, . . . , N.

In this example implementation, the base station 104 includes a condition configuration (i.e., condExecutionCond-r16) in at least one of the CondReconfigToAddMod-r16 IE(s). In some implementations, if the UE 102 supports a conditional procedure (e.g., conditional handover (CHO), conditional PSCell addition (CPA), or conditional PSCell change (CPC)), the UE 102 evaluates one or more conditions configured in the condExecutionCond-r16 field for the conditional procedure. If the UE 102 detects that at least one or all of the one or more conditions in the condExecutionCond-r16 field in a particular CondReconfigToAddMod-r16 IE is met, the UE 102 immediately applies configurations in an RRCReconfiguration message in the CondReconfigToAddMod-r16 IE (e.g., as described in 3GPP specification 38.331). In some implementations, the base station 104 does not include a condition configuration (i.e., condExecutionCond-r16) in any one or some of the CondReconfigToAddMod-r16 IE(s). Thus, the UE 102 is not configured to perform or does not perform any evaluation (i.e., detection or determination) of a condition for a conditional procedure (e.g., conditional handover) for the CondReconfigToAddMod-r16 IE(s) not including a condition configuration (i.e., condExecutionCond-r16).

In some implementations, the release list is a CondReconfigToRemoveList-r16 IE. In further implementations, the base station 104 includes one or more CondReconfigID IEs in the CondReconfigToRemoveList-r16 IE to release one or more CondReconfigToAddMod-r16 IEs of the CondReconfigToAddMod-r16 IE(s) 1, . . . , N. The one or more CondReconfigToAddMod-r16 IEs are identified by the one or more CondReconfigID IEs.

### Example Implementation 4

Example Implementation 4 is similar to Example Implementation 3, except that, in some implementations, a new indicator (e.g., fastServingCellChange-r18 field) is optionally included in a CondReconfigToAddMod-r16 IE. In some implementations, the new indicator indicates that the CondReconfigToAddMod-r16 IE (i.e., an RRCReconfiguration message or condRRCReconfig-r16 in the IE) is configured for fast serving cell change (i.e., see description for event 312). If the base station 104 does not include the new indicator in a CondReconfigToAddMod-r16 IE, the CondReconfigToAddMod-r16 IE is not configured for fast serving cell change.

CondReconfigToAddModList-r16 ::= SEQUENCE (SIZE (1..
maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF |
| MeasId | OPTIONAL, -- Need M |
| condRRCReconfig-r16 | OCTET STRING (CONTAINING |
| RRCReconfiguration) | OPTIONAL, -- Cond condReconfigAdd |

```
  ...,
  [[
```

| | |
|---|---|
| condExecutionCondSCG-r17 | OCTET STRING (CONTAINING |
| CondReconfigExecCondSCG-r17) | OPTIONAL -- Need M |

```
  ]],
  [[
```

| | |
|---|---|
| fastServingCellChange-r18 | ENUMERATED {true} |

OPTIONAL, -- Cond fastServingCellChange M
]]
}

| | |
|---|---|
| CondReconfigExecCondSCG-r17 ::= | SEQUENCE (SIZE (1..2)) OF MeasId |

CondReconfigToRemoveList-r16::=SEQUENCE (SIZE (1 . . . maxNrofCondCells-r16)) OF CondReconfigId-r16

### Example Implementation 5

Some implementations of Example Implementations 3 and 4 may involve the UE 102 supporting conditional procedures (e.g., conditional handover (CHO), conditional PSCell addition (CPA), and/or conditional PSCell change (CPC)). If the UE 102 does not support the conditional procedures, the base station 104 does not configure or enable fast serving cell change for the UE 102. Thus, Example Implementation 5 decouples from the conditional procedures.

ReconfigToAddModList ::= SEQUENCE (SIZE (1..maxNrofConfigCells)) OF
ReconfigToAddMod

| | |
|---|---|
| ReconfigToAddMod ::= | SEQUENCE { |
| configId | ConfigId, |
| cellGroupConfig | OCTET STRING (CONTAINING |
| RRCReconfiguration) | OPTIONAL, |

...
}
ReconfigToReleaseList ::= SEQUENCE (SIZE (1.. maxNrofConfigCells))
OF ConfigId
maxNrofConfigCells ::= 8

In some implementations, the first addition or modification list is a first ReconfigToAddModList IE and the second addition or modification list is a second ReconfigToAddModList IE. The element 1 is a ReconfigToAddMod IE 1, and the element(s) 2, . . . , N are ReconfigToAddMod IE(s) 2, . . . , N, respectively. The ID 1 and configuration 1 are a ConfigId and an RRCReconfiguration IE in the ReconfigToAddMod IE 1. The ID(s) 2, . . . , N and configuration(s) 2, . . . , N are a ConfigId and an RRCReconfiguration IE in the ReconfigToAddMod IE(s) 2, . . . , N, respectively. In some implementations, the first ReconfigToAddModList IE includes the ReconfigToAddMod IE 1 and the second ReconfigToAddModList IE includes the ReconfigToAddMod IE(s) 2, . . . , N. In further implementations, the first ReconfigToAddModList IE includes the ReconfigToAddMod IE 1, . . . , N.

In some implementations, the release list is a ReconfigToReleaseList IE. In further implementations, the base station 104 includes one or more ConfigID IEs in the ReconfigToReleaseList IE to release one or more ReconfigToAddMod IEs of the ReconfigToAddMod IE(s) 1, . . . , N. The one or more ReconfigToAddMod IEs are identified by the one or more ConfigID IEs.

### Example Implementation 6

ReconfigToAddModList ::= SEQUENCE (SIZE (0.. maxNrofConfigCells)) OF
ReconfigToAddMod

| | |
|---|---|
| ReconfigToAddMod ::= | SEQUENCE { |
| cellGroupConfig | OCTET STRING (CONTAINING |
| RRCReconfiguration) | OPTIONAL, |

...
}
maxNrofConfigCells ::= 8

Example Implementation 6 is similar to Example Implementation 5, except that the ReconfigToAddMod IE does not include a ConfigId. In some implementations, the ID(s) 1, . . . , N are implicitly indicated by the order of the ReconfigToAddMod IE(s) 1, . . . , N in the first or second ReconfigToAddModList. For example, the ReconfigToAddMod IE 1 is the first IE in the first ReconfigToAddModList IE, which implicitly indicates that the ID 1 has value X. X can be zero or one. If the first ReconfigToAddModList IE includes the ReconfigToAddMod IE(s) 1, . . . , N in sequence, the ID(s) 1, . . . , N have values X, X+1, . . . , X+(N−1). In some implementations, if the base station 104 transmits the second ReconfigToAddModList IE to the UE 102, the UE 102 and base station 104 replace the first ReconfigToAddModList IE with the second ReconfigToAddModList IE. If the second ReconfigToAddModList IE includes the ReconfigToAddMod IE(s) 2, . . . , N in sequence, the ID(s) 2, . . . , N are values X, X+1, . . . , X+N−2. If the second ReconfigToAddModList IE includes the ReconfigToAddMod IE(s) 1, . . . , N in sequence, the ID(s) 1, . . . , N have values X, X+1, . . . , X+N−1. In some alternative implementations, the ID(s) 1, . . . , N are the cell ID(s) 1, . . . , N.

In some implementations, the base station 104 transmits a ReconfigToAddModList IE including zero ReconfigToAddMod IE to release all of the ReconfigToAddMod IE(s) 1, . . . , N.

In the Example Implementations 5 and 6, the “ReconfigToAddModList”, “ReconfigToAddMod”, “configId”, “ConfigId”, “cellGroupConfig”, “ReconfigToReleaseList”, and “maxNrofConfigCells” are exemplary and should not restrict scope and application of the invention.

### Example Implementation 7

Example Implementation 7 is a combination of the Example Implementations 1 and 5, as shown below. Depending on implementation, any of the configuration(s) 1, . . . , N is a CellGroupConfig IE or an RRCReconfiguration message. Examples and implementations described for the Example Implementations 1 and 5 can apply to Example Implementation 7.

ReconfigToAddModList ::= SEQUENCE (SIZE (1.. maxNrofConfigCells)) OF
ReconfigToAddMod

| | |
|---|---|
| ReconfigToAddMod ::= | SEQUENCE { |
| configId | ConfigId, |
| cellGroupConfig | CHOICE { |
| cellGroupConfig1 | OCTET STRING (CONTAINING |
| CellGroupConfig) | OPTIONAL, |
| cellGroupConfig2 | OCTET STRING (CONTAINING |
| RRCReconfiguration) | OPTIONAL, |

```
  }
  ...
}
ReconfigToReleaseList ::= SEQUENCE (SIZE (1.. maxNrofConfigCells))
OF ConfigId
```

maxNrofConfigCells::=8After receiving the RRC reconfiguration in the event 318 or transmitting the RRC reconfiguration complete message in the event 320, the UE 102 transmits 324 at least one measurement report to the DU 174, similar to the event 304. In some implementations, the DU 174 transmits 326 a DU-to-CU message including the at least one measurement report to the CU 172, similar to the event 306. In other implementations, the DU 174 does not transmit the at least one measurement report to the CU 172. In some implementations, the at least one measurement report of the event 324 includes L1 measurement report(s), L3 measurement repot(s), and/or new-type measurement report(s), as described for the event 304. In some implementations, the UE 102 transmits 324 the at least one measurement report on PUCCH(s) and/or PUSCH(s) to the DU 174, similar to the event 304. In other implementations, the UE 102 transmits 324 at least one MAC CE including the at least one measurement report to the DU 174, similar to the event 304. In some implementations, each of the at least one measurement report of the event 324 is not an RRC message.

In some implementations, the UE 102 transmits 324 the at least one measurement report to the DU 174 in accordance with at least one measurement configuration. The at least one measurement configuration configures the UE 102 to perform measurements and report measurement results. The CU 172 transmits the at least one measurement configuration to the UE 102 via the DU 174. For example, the CU 172 transmits one or more RRC messages (e.g., RRCReconfiguration message(s)) including the at least one measurement configuration to the UE 102 via the DU 174 after the event 306 or 316. The one or more RRC messages may or may not include the RRC reconfiguration message of the event 316. In accordance with the at least one measurement configuration, the UE 102 performs measurements on one or more reference signals. In some implementations, the one or more reference signals include one or more SSBs and/or one or more CSI-RSs. The UE 102 obtains the at least one L1 measurement result and/or at least one L3 measurement result from the measurements, and the UE 102 includes the at least one L1 measurement result and/or at least one L3 measurement result in the at least measurement report of the event 324. The DU 174 transmits the one or more reference signals on the cells 124A and 124B, and, in some implementations, the cell 124C and/or other cell(s). In some implementations, the at least one measurement configuration includes L3 measurement configuration(s) (e.g., MeasConfig IE(s)), L1 measurement configuration(s) (e.g., CSI-MeasConfig IE(s)), and/or new-type measurement configuration(s), as described for the event 304.

In some implementations, the new-type measurement configuration(s) as described for the events 304 and 324 are similar to the L3 measurement configuration(s). For example, the new-type measurement configuration(s) include a portion of the configuration parameters defined in a MeasConfig IE. In other implementations, the new-type measurement configuration(s) as described for the events 304 and 324 are similar to the L1 measurement configuration(s). For example, the new-type measurement configuration(s) include a portion of the configuration parameters (e.g., CSI-ResourceConfig IE(s) and/or CSI-ReportConfig IE(s)) defined in a CSI-MeasConfig IE.

After (e.g., in response to) receiving the at least one measurement report in the event 324, the DU 174 transmits 330 a first configuration activation command to the UE 102 to activate the configuration 1. For example, the base station 104 transmits the first configuration activation command on the cell 124A. In another example, the base station 104 transmits the first configuration activation command on the cell 124D. In some implementations, the DU 174 includes the ID 1 of in the first configuration activation command. The UE 102 determines and activates the configuration 1, in accordance with the first configuration activation command and ID 1. In other implementations, the DU 174 includes, in the first configuration activation command, the cell index 1 (e.g., a serving cell index) or cell ID 1 included in the configuration 1. The UE 102 determines and activates the configuration 1, in accordance with the first configuration activation command and the cell index 1 or cell ID 1.

In yet other implementations, the DU 174 includes a bit map in the first configuration activation command to activate the configuration 1, instead of the ID 1, cell ID 1, or cell index 1 (e.g., a serving cell index). The number of bits in the bit map is larger than or equal to “N”. In some implementations, bit 1, . . . , N corresponds to the configuration(s) 1, . . . , N, respectively, and the DU 174 sets a corresponding bit (e.g., bit 1) in the bit map to a first value to indicate the ID 1 or the configuration 1. In further implementations, bit 0, . . . , N−1 corresponds to the configuration(s) 1, . . . , N, respectively, and the DU 174 sets a corresponding bit (e.g., bit 0) in the bit map to a first value to indicate the ID 1 or the configuration 1. Thus, the UE 102 can determine the particular ID or particular configuration in accordance with the bit 1 or bit 0 set to the first value in the bit map. In such implementations, the DU 174 sets the remaining bits in the bit map to a second value to indicate that the reset of the configuration(s) 1, . . . , N is not activated. In some implementations, the first value is one and the second value is zero. In other implementations, the first value is zero and the second value is one. In some implementations, if the DU 174 determines to activate another configuration (e.g., configuration K) in addition to the configuration 1, the DU 174 sets the corresponding bit (e.g., bit K or bit K−1) in the bit map to the first value, where 1<=K<=N.

In some implementations, the at least one measurement report (e.g., L1 measurement report(s) or new-type measurement report(s)) of the event 324 includes at least one measurement result for the cell 124B. The DU 174 determines to activate the configuration 1 because the at least one measurement result indicates that signal strength or quality of the cell 124B is above a second predetermined threshold. The second predetermined threshold is different from the first predetermined threshold. In some implementations, the second predetermined threshold is larger than the first predetermined threshold. In such an implementation, the at least one measurement report of the event 324 indicates that signal strength or quality of the cell 124B is suitable for communication with the UE 102. In further implementations, the second predetermined threshold is equal to the first predetermined threshold. In such an implementation, the at least one measurement report of the event 324 indicates that signal strength or quality of the cell 124B has been continuously above the second predetermined threshold or the first predetermined threshold. This also indicates that the cell 124B is suitable for communication with the UE 102. Thus, the DU 174 determines to activate the configuration 1 (i.e., fast serving cell change to the cell 124B) in response to the signal strength or quality of the cell 124B being above the second predetermined threshold.

In some implementations, the at least one measurement report (e.g., L3 measurement report(s)) of the events 324 and 326 includes at least one measurement result for the cell 124B. The CU 172 determines to activate the configuration 1 because the at least one measurement result indicates that signal strength or quality of the cell 124B is above a second predetermined threshold. The second predetermined threshold is different from the first predetermined threshold. In some implementations, the second predetermined threshold is larger than the first predetermined threshold. In such an implementation, the at least one measurement report of the event 326 indicates that signal strength or quality of the cell 124B is suitable for communication with the UE 102. In further implementations, the second predetermined threshold is equal to the first predetermined threshold. In such an implementation, the at least one measurement report of the event 326 indicates that signal strength or quality of the cell 124B has been continuously above the second predetermined threshold or the first predetermined threshold. The at least one measurement report also indicates that the cell 124B is suitable for communication with the UE 102. Thus, the CU 172 determines to activate the configuration 1 (i.e., fast serving cell change to the cell 124B) in response to determining that signal strength or quality of the cell 124B is above the second predetermined threshold.

In response to the determination, the CU 172 transmits 328 a fourth CU-to-DU message to the DU 174 to activate the configuration 1. In response to the fourth CU-to-DU message, the DU 174 transmits 330 the first configuration activation command to the UE 102 and, in some implementations, transmits a fourth DU-to-CU message to the CU 172. In some implementations, the CU 172 includes the cell index 1 (e.g., a serving cell index) in the fourth CU-to-DU message. Thus, in some such implementations, the DU 174 determines to activate the configuration 1 in accordance with the cell index 1. In other implementations, the CU 172 includes the cell ID 1 in the fourth CU-to-DU message. Thus, the DU 174, in some such implementations, determines to activate the configuration 1 in accordance with the cell ID.

In yet other implementations, the CU 172 includes the ID 1 in the fourth CU-to-DU message. Thus, the DU 174, in some such implementations, determines to activate the configuration 1 in accordance with the ID 1. In some implementations, the fourth CU-to-DU message and fourth DU-to-CU message are a UE Context Modification Request message and a UE Context Modification Response message, respectively. In other implementations, the fourth CU-to-DU message is a new interface message (e.g., an F1 application protocol (F1AP) message (e.g., defined in 3GPP specification 38.473 v18.0.0 and/or later versions)). In other implementations, the fourth DU-to-CU message is a new interface message (e.g., a new F1AP message (e.g., defined in 3GPP specification 38.473 v18.0.0 and/or later versions).

In some implementations, when the DU 174 determines to activate the configuration 1 or transmits the first configuration activation command as described above, the DU 174 transmits 329 a fifth DU-to-CU message to the CU 172. In some implementations, the CU 172 suspends or stops DL data transmission for the UE 102 in response to the fifth DU-to-CU message. In further implementations, when suspending or stopping DL data transmission for the UE 102, the CU 172 buffers DL data of the UE 102 that the CU 172 receives, in further implementations, from a core network or an edge server. In some implementations, in the fifth DU-to-CU message, the DU 174 indicates that a serving cell change occurs (e.g., a serving cell change from the cell 124A to cell 124B). In other implementations, in the fifth DU-to-CU message, the DU 174 indicates to suspend or stop DL transmission for the UE 102.

In some implementations, the fifth DU-to-CU message is an existing F1AP message (e.g., defined in 3GPP specification 38.473). In other implementations, the fifth DU-to-CU message is a dedicated F1AP message (e.g., defined in 3GPP specification 38.473 v18.0.0 and/or later versions) specifically defined for the purpose of indicating stoppage of DL transmissions. In yet other implementations, the fifth DU-to-CU message is an existing frame (e.g., defined in 3GPP specification 38.474). In yet other implementations, the fifth DU-to-CU message is a dedicated frame (e.g., defined in 3GPP specification 38.474 v18.0.0 and/or later versions) specifically defined for the purpose of indicating stoppage of DL transmissions.

In some implementations, the first configuration activation command is a MAC CE included in a MAC PDU that the UE 102 receives from the DU 174 in the event 330. In some implementations, the MAC CE is a new MAC CE (e.g., defined in 3GPP specification 38.321 v18.0.0 and/or later versions). In some implementations, the DU 174 includes a subheader identifying the MAC CE in the MAC PDU, and the UE 102 identifies the MAC CE in the MAC PDU in accordance with the subheader. In further implementations, the subheader includes a logical channel ID or extended logical channel ID (e.g., defined in a 3GPP specification) to identify the MAC CE. For example, the logical channel ID or extended logical channel ID are newly defined (e.g., in 3GPP specification 38.321 v18.0.0 and/or later versions). In other implementations, the first configuration activation command is a DCI that the UE 102 receives on a PDCCH in the event 330. The DU 174 generates a CRC for the DCI, scrambles the CRC with a first C-RNTI of the UE 102, and transmits the DCI and scrambled CRC on the PDCCH in the event 330. In some implementations, a format of the DCI is an existing DCI format (e.g., defined in a 3GPP specification (e.g., 38.212)). In further implementations, the format of the DCI is a new DCI format (e.g., defined in a 3GPP specification (e.g., 38.212 v18.0.0 or later versions)).

In some implementations, the DU 174 does not perform security protection (e.g., integrity protection and/or encryption) on the first configuration activation command. Refraining from performing such speeds up processing of the first configuration activation command in the UE 102 because the UE 102 does not spend time to perform a security check (e.g., decryption and/or integrity check) on the first configuration activation command.

In some implementations, after receiving the first configuration activation command, the UE 102 transmits 331 an acknowledgement to the DU 174 on the cell 124A or cell 124D to indicate that the UE 102 receives the first configuration activation command. In some implementations, the acknowledgement is a HARQ ACK. In other implementations, the acknowledgement is a MAC CE. For example, the MAC CE is an existing MAC CE (e.g., defined in 3GPP specification 38.321 v17.1.0). In another example, the MAC CE is a new MAC CE (e.g., defined in 3GPP specification 38.321 v18.0.0 and/or later versions). In yet other implementations, the acknowledgement is a PUCCH transmission.

In some implementations, the CU 172 transmits 316 the RRC reconfiguration message in response to the L3 measurement report for the cell 124B that the CU 172 receives in the event 306. In further implementations, the CU 172 transmits a first RRC reconfiguration message including a MeasConfig IE to the UE 102 to configure the UE 102 to transmit the L3 measurement report. In some implementations, the DU 174 transmits 330 the first configuration activation command in response to the L1 measurement report for the cell 124B that the DU 174 receives in the event 324. In further implementations, the CU 172 transmits a second RRC reconfiguration message including a CSI-MeasConfig IE to the UE 102 to configure the UE 102 to transmit the L1 measurement report. In some implementations, the first and second RRC reconfiguration messages are the same message (i.e., the same instance). In other implementations, the first and second RRC reconfiguration messages are different messages. In some implementations, the second RRC reconfiguration message is the RRC reconfiguration message of the event 316. In other implementations, the second RRC reconfiguration message is different from the RRC reconfiguration message of the event 316.

After (e.g., in response to) receiving the first configuration activation command, the UE 102 identifies the particular configuration (e.g., the configuration 1) in accordance with the particular ID (e.g., the ID 1) and immediately applies the configuration 1. In some implementations, the UE 102 performs 332 a random access procedure on the cell 124B with the DU 174 in response to applying the configuration 1. In some implementations, the UE 102 disconnects from the cell 124A after (e.g., in response to) receiving the first configuration activation command or transmitting the acknowledgement. In other words, the UE 102 stops communicating on the cell 124A after (e.g., in response to) receiving 330 the first configuration activation command or transmitting 331 the acknowledgement. In such cases, the UE 102 performs 332 the random access procedure after disconnecting from the cell 124A. In some implementations, the UE 102 determines whether to perform the random access procedure in accordance with the configuration 1. In some implementations, if the configuration 1 configures the UE 102 to perform a random access procedure, the UE 102 performs the random access procedure in the event 332. For example, the configuration 1 includes a reconfiguration with sync configuration (e.g., Reconfiguration WithSync IE) to configure the UE 102 to perform a random access procedure. Otherwise, if the configuration 1 does not configure the UE 102 to perform a random access procedure or configures the UE 102 to skip a random access procedure, the UE 102 refrains from performing a random access procedure with the DU 174 upon receiving the first configuration activation command. In such cases, the UE 102 skips the event 316. For example, if the configuration 1 excludes a reconfiguration with sync configuration, the configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In cases where the UE 102 performs 332 the random access procedure, the UE 102 communicates 336 with the DU 174 on cell 124B using the configuration 1 and communicates with the CU 172 via the DU 174 after successfully completing the random access procedure. For example, the UE 102 communicates UL PDUs, DL PDUs, and/or physical layer signals (e.g., PUCCH transmissions and PDCCH transmissions) with the base station 104 in the event 318. In such cases, the UE 102 successfully completes the random access procedure when the UE 102 receives a contention resolution from the DU 174. In cases where the random access procedure is a four-step random access procedure, the UE 102 transmits a Message 3 including a UE identity to the DU 174 via the cell 124B in the random access procedure. In cases where the random access procedure is a two-step random access procedure, the UE 102 transmits a Message A including the UE identity to the DU 174 via the cell 124B in the random access procedure. In some implementations, if the configuration 1 includes a second C-RNTI, the UE identity is the second C-RNTI of the UE 102. Otherwise, if the configuration 1 does not include a C-RNTI, the UE identity is the first C-RNTI. In cases where the random access procedure is a contention free random access procedure, the UE 102 transmits the dedicated random access preamble to the DU 174 via the cell 124B. In such cases, the configuration 1 includes the dedicated random access preamble.

The DU 174 identifies or determines that the UE 102 connects to the cell 124B upon receiving the UE identity or the dedicated preamble from the UE 102 in the random access procedure.

In some implementations, the UE 102 transmits an RRC message (e.g., RRC reconfiguration complete message) to the CU 172 via the DU 174 and the cell 124B to indicate that the UE 102 applies the configuration 1. In some implementations, the UE 102 includes the RRC message in the Message 3. In further implementations, the UE 102 includes the RRC message in the Message A. In yet further implementations, the UE 102 transmits the RRC message after completing the random access procedure. In other implementations, if the UE 102 maintains communication on the cell 124A with the base station 104 (i.e., the UE 102 does not disconnect from the cell 124A), the UE 102 transmits the RRC message to the base station 104 via the cell 124A. In yet other implementations, the UE 102 refrains from transmitting the RRC message to the base station 104 in response to applying the configuration 1 or receiving the first configuration activation command.

In some cases where the UE 102 skips the random access procedure, the UE 102 directly communicates 336 with the base station 104 on cell 124B in accordance with the configuration 1 after (e.g., in response to) receiving the first configuration activation command. For example, the UE 102 communicates UL PDUs, DL PDUs, and/or physical layer signals (e.g., PUCCH transmissions and PDCCH transmissions) with the base station 104 in the event 318. In some such cases, the UE 102 transmits 336 at least one PUCCH transmission on the cell 124B to the DU 174 in accordance with the configuration 1, after (e.g., in response to) receiving the first configuration activation command. In some implementations, the DU 174 transmits at least one DCI on a PDCCH on the cell 124B to the UE 102 to command the UE 102 to transmit the at least one PUCCH or PUSCH transmission, after transmitting the first configuration activation command. The DU 174 identifies or determines that the UE 102 connects to the cell 124B upon receiving the PUCCH or PUSCH transmission. In other implementations, the UE 102 transmits the at least one PUCCH or PUSCH transmission regardless of receiving a DCI on a PDCCH on the cell 124B. The DU 174 identifies or determines that the UE 102 connects to the cell 124B upon receiving the PUCCH or PUSCH transmission. In some implementations, the UE 102 transmits an RRC message (e.g., RRC reconfiguration complete message) to the CU 172 via the DU 174 and the cell 124B to indicate that the UE 102 applies the configuration 1. The CU 172 identifies or determines that the UE 102 connects to the cell 124B upon receiving the RRC message. In other implementations, if the UE 102 maintains communication on the cell 124A with the base station 104 (i.e., the UE 102 does not disconnect from the cell 124A), the UE 102 transmits the RRC message to the base station 104 via the cell 124A. In yet other implementations, the UE 102 refrains from transmitting the RRC message to the base station 104 in response to applying the configuration 1 or receiving the first configuration activation command.

In some implementations, when the DU 174 determines that the UE 102 successfully connects to the cell 124B in the event 332 or 336, the DU 174 transmits 334 a DU-to-CU message (e.g., Access Success message) to the CU 172. In some implementations, the DU 174 includes a cell ID of the cell 124B in the DU-to-CU message of the event 334. Depending on the implementation, the cell ID is a PCI or a CGI. Thus, the CU 172 determines that the UE 102 connects to the cell 124B upon receiving the DU-to-CU message of the event 334. In further implementations, when the DU 174 determines that the UE 102 successfully connects to the cell 124B in the event 332 or 336, the DU 174 transmits a DL Data Delivery Status message or frame to the CU 172. In some implementations, when the CU 172 receives 334 the DU-to-CU message, the CU 172 resumes or continues DL data transmission for the UE 102. In further implementations, after (e.g., in response to) resuming or continuing DL data transmission for the UE 102, the CU 172 transmits DL data of the UE 102 to the DU 174, which in turn transmits the DL data to the UE 102 in the event 336.

In some implementations, when determining that the UE 102 connects to the cell 124B, transmitting 330 the first configuration activation command, or receiving 331 the acknowledgement, the DU 174 stops communicating with the UE 102 on the cell 124A. In some implementations, when determining that the UE 102 connects to the cell 124B, transmitting 330 the first configuration activation command, or receiving 331 the acknowledgement, the DU 174 releases resources of the cell 124A configured for the UE 102.

The events 304, 306, 390, 392, 316, 318, 320, 322 are collectively referred to in FIG. 3 as a serving cell configuration procedure 380. The events 324, 326, 328, 330, 331, 332, 334, 336, 394 are collectively referred to in FIG. 3 as a serving cell change procedure 382.

In some implementations, the DU 174 generates the configuration 1 and/or configuration(s) 2, . . . , N as full configuration(s) replacing the first configuration or a particular configuration in the first configuration. In some implementations, if the configuration 1 is a full configuration, the UE 102 and DU 174 communicate 336 with each other in accordance with the configuration 1 instead of the first configuration or particular configuration. In some implementations, the DU 174 includes an indication that the configuration 1 is a full configuration in the configuration 1. In other implementations, the RRC reconfiguration message of the events 316, 318 includes an indication that the configuration 1 is a full configuration. In yet other implementations, the first container includes an indication that the configuration 1 is a full configuration. In yet other implementations, the element 1 (e.g., ConfigToAddMod IE, CellGroupConfigToAddMod, MobilityToAddMod IE, MobilityConfigToAddMod IE, or CellGroupConfigToAddMod IE) includes an indication that the configuration 1 is a full configuration. In some implementations, the UE 102 determines that configuration 1 is a full configuration based on the indication that the configuration 1 is a full configuration. In some implementations, the indication for the configuration 1 is different from a fullConfig field (e.g., defined in the current 3GPP specifications). In other implementations, the indication for the configuration 1 is a fullConfig field in an RRCReconfiguration message (e.g., defined in the current 3GPP specifications).

In other implementations, the DU 174 generates the configuration 1 and/or configuration(s) 2, . . . , N as delta configuration(s) augmenting at least a portion of the first configuration. In other words, the DU 174 generates the configuration(s) 1, . . . , N on top of the first configuration. For example, if the configuration 1 is a delta configuration, the UE 102 and DU 174 augment the at least the portion of the first configuration with the configuration 1. Thus, the UE 102 and base station 104 communicate 336 with each other in accordance with the configuration 1 and unaugmented portion of the first configuration. In some implementations, the configuration 1 includes an indication that the configuration 1 is a delta configuration. In other implementations, the first container includes an indication that the configuration 1 is a delta configuration. In yet other implementations, the element 1 includes an indication that the configuration 1 is a delta configuration. In some implementations, the UE 102 determines that configuration 1 is a full configuration based on the indication that the configuration 1 is a delta configuration. In some alternative implementations, the configuration 1, first container, or element 1 excludes an indication that the configuration 1 is a full configuration to indicate that the configuration 1 is a delta configuration. In further implementations, the UE 102 determines that the configuration 1 is a delta configuration based on a determination that the indication is excluded in the configuration 1, first container, or element 1.

In some implementations, if the configuration 1 is a full configuration, the UE 102 releases the first configuration or the particular configuration in the first configuration after (e.g., in response to) receiving 330 the first configuration activation command, transmitting 331 the acknowledgement, successfully performing the 332 the random access procedure, or receiving the first DCI on a PDCCH addressed to the UE identity of the UE 102 on the cell 124B. In some implementations, if the configuration 1 is a full configuration, the DU 174 releases the first configuration or the particular configuration in the first configuration after (e.g., in response to) transmitting 330 the first configuration activation command, receiving 331 the acknowledgement, successfully performing the 332 the random access procedure, or receiving a particular transmission from the UE 102 on the cell 124B. In some implementations, the particular transmission is a PUCCH transmission. In further implementations, the transmission is a PUSCH transmission. In some implementations, after transmitting the first configuration activation command, the DU 174 generates a DCI and a CRC of the DCI, scrambles the CRC with the UE identity of the UE 102, and transmits the DCI and scrambled CRC on a PDCCH on the cell 124B. When the UE 102 receives the DCI and scrambled CRC and verifies the scrambled CRC is valid using the UE identity, the UE 102 transmits the PUSCH transmission to the DU 174 on the cell 124B.

In some implementations, the first configuration or the particular configuration is a first CellGroupConfig IE (i.e., the first configuration includes configuration parameters defined in the first CellGroupConfig IE), and the configuration 1 is a second CellGroupConfig IE.

In some implementations, the UE 102 uses a UE MAC entity (e.g., MAC 204B) to communicate with the DU 174 (e.g., the events 302, 304, 318, 320, 324, 330, and/or 331). In some implementations, the base station 104 configures whether the UE 102 resets the UE MAC entity upon receiving the first configuration activation command. In some implementations, the base station 104 includes a MAC reset indication in the configuration 1 or element 1 to configure the UE 102 to reset the UE MAC entity, and excludes the MAC reset indication in the configuration 1 or element 1 to configure the UE 102 not to reset the UE MAC entity. If the configuration 1 or element 1 includes the MAC reset indication, the UE 102 resets the UE MAC entity in response to the MAC reset indication, upon receiving the first configuration activation command.

Otherwise, if the configuration 1 or element 1 does not include the MAC reset indication, the UE 102 refrains from resetting the UE MAC entity upon or when receiving the first configuration activation command. In some implementations, if the configuration 1 or element 1 does not include the MAC reset indication and includes an indication that the configuration is a full configuration, the UE 102 resets the UE MAC entity upon or when receiving 330 the first configuration activation command. Otherwise, if the configuration 1 or element 1 does not include the MAC reset indication and the indication that the configuration is a full configuration, the UE 102 refrains from resetting the UE MAC entity upon or when receiving 330 the first configuration activation command.

In some implementations, the base station 104 (e.g., the DU 174 or CU 172) uses a DU MAC entity (e.g., NR MAC 204B) to communicate with the UE 102 (e.g., the events 302, 304, 318, 320, 324, 330, and/or 331). If the base station 104 includes the MAC reset indication in the configuration 1 or element 1, the DU 174 resets the DU MAC entity in response to the MAC reset indication, after transmitting 330 the first configuration activation command, receiving 331 the acknowledgement, or determining that the UE 102 connects to the cell 124B in the event 332 or 336.

Otherwise, if the configuration 1 or element 1 does not include the MAC reset indication, the DU 174 refrains from resetting the DU MAC entity after (e.g., in response to) transmitting 330 the first configuration activation command. Thus, the DU 174 continues to use the retained (i.e., un-reset) DU MAC entity to communicate with the UE 102 after transmitting 330 the first configuration activation command, receiving 331 the acknowledgement, or determining that the UE 102 connects to the cell 124B in the event 332 or 336.

In some implementations, the DU 174 includes the MAC reset indication in a MAC-CellGroupConfig IE in the configuration 1 (e.g., CellGroupConfig IE). In other implementations, the DU 174 includes the MAC reset indication in the CellGroupConfig IE and outside the MAC-CellGroupConfig IE. In yet other implementations, the DU 174 includes the MAC reset indication in the element 1 and outside the configuration 1.

In some implementations, if the configuration 1 or element 1 does not include the MAC reset indication and includes an indication that the configuration 1 is a full configuration, the DU 174 resets the DU MAC entity after transmitting 330 the first configuration activation command, receiving 331 the acknowledgement, or determining that the UE 102 connects to the cell 124B in the event 332 or 336. Alternatively, the DU 174 releases the DU MAC entity and establishes a new DU MAC entity for communication with the UE 102 via the cell 124B instead of resetting the DU MAC entity. Otherwise, if the configuration 1 or element 1 does not include the MAC reset indication and the indication that the configuration 1 is a full configuration, the DU 174 refrains from resetting the DU MAC entity after (e.g., in response to) transmitting 330 the first configuration activation command.

In alternative implementations, the base station 104 (e.g., the DU 174 or CU 172) includes a MAC retention indication in a configuration or element (e.g., the configuration 1 or element 1) to configure the UE 102 to not reset the UE MAC entity, and the base station 104 excludes the MAC retention indication in the configuration or element to configure the UE 102 to reset the UE MAC entity. If the configuration or element includes the MAC retention indication, the UE 102 refrains from resetting the UE MAC entity in response to the MAC retention indication, upon receiving a configuration activation command (e.g., the first configuration activation command). Otherwise, if the configuration or element does not include the MAC retention indication, the UE 102 resets the UE MAC entity upon or when receiving the configuration activation command.

The DU 174 uses a DU MAC entity (e.g., NR MAC 204B) to communicate with the UE 102 (e.g., the events 302, 304, 318, 320, 324, 330, and/or 331). If the base station 104 includes the MAC retention indication in the configuration or element (e.g., the configuration 1 or element 1), the DU 174 refrains from resetting a DU MAC entity in response to the MAC retention indication after transmitting the configuration activation command (e.g., the first configuration activation command) to the UE 102. Thus, the DU 174 continues to use the retained (i.e., un-reset) DU MAC entity to communicate with the UE 102 after transmitting 330 the first configuration activation command, receiving 331 the acknowledgement, or determining that the UE 102 connects to the cell 124B at event 332 or 336.

In some implementations, the DU 174 includes the MAC retention indication in a MAC-CellGroupConfig IE in the configuration 1 (e.g., CellGroupConfig IE). In other implementations, the DU 174 includes the MAC retention indication in the CellGroupConfig IE and outside the MAC-CellGroupConfig IE. In yet other implementations, the DU 174 includes the MAC retention indication in the element 1 and outside the configuration 1.

Otherwise, if the configuration 1 or element 1 does not include the MAC retention indication, the DU 174 resets the DU MAC entity after (e.g., in response to) transmitting 330 the first configuration activation command.

In some implementations, base station 104 does or does not include an indication that the configuration 1 is a full configuration. If the base station 104 includes, in the configuration 1 or element 1, the indication that the configuration 1 is a full configuration, the base station 104 refrains from including the MAC retention indication in the configuration 1 or element 1. Otherwise, in further implementations, if the base station 104 does not include, in the configuration 1 or element 1, the indication that the configuration 1 is a full configuration, the base station 104 includes the MAC retention indication in the configuration 1 or element 1.

In some alternative implementations, the base station 104 (e.g., the DU 174 or CU 172) includes a MAC partial reset indication in a configuration or element (e.g., the configuration 1 or element 1) to configure the UE 102 to partially reset the UE MAC entity, and the base station 104 excludes the MAC partial reset indication in the configuration or element to configure that the UE 102 fully resets the UE MAC entity. If the configuration or element includes the MAC partial reset indication, the UE 102 partially resets the UE MAC entity upon receiving a configuration activation command (e.g., the first configuration activation command). Otherwise, if the configuration or element does not include the MAC partial reset indication, the UE 102 fully resets the UE MAC entity after (e.g., in response to) receiving the configuration activation command. In some implementations, when the UE partially resets the UE MAC entity, the UE 102 retains (e.g., maintains or keeps) the operation state of the UE MAC entity or omits one or more actions that the UE 102, in some implementations, performs when the UE 102 fully resets the UE MAC entity.

If the base station 104 includes the MAC partial reset indication in the configuration or element (e.g., the configuration 1 or element 1), the DU 174 partially resets the DU MAC entity in response to the MAC partial reset indication after transmitting the configuration activation command (e.g., the first configuration activation command) to the UE 102.

In some implementations, the DU 174 includes the MAC partial reset indication in a MAC-CellGroupConfig IE in the configuration 1 (e.g., CellGroupConfig IE). In other implementations, the DU 174 includes the MAC partial reset indication in the CellGroupConfig IE and outside the MAC-CellGroupConfig IE. In yet other implementations, the DU 174 includes the MAC partial reset indication in the element 1 and outside the configuration 1.

Otherwise, if the configuration 1 or element 1 does not include the MAC partial reset indication, the DU 174 fully resets the DU MAC entity after (e.g., in response to) transmitting 330 the first configuration activation command. In some implementations, base station 104 does or does not include an indication that the configuration 1 is a full configuration. In some implementations, if the base station 104 includes, in the configuration 1 or element 1, the indication that the configuration 1 is a full configuration, the base station 104 refrains from including the MAC partial reset indication in the configuration 1 or element 1. Otherwise, in further implementations, if the base station 104 does not include, in the configuration 1 or element 1, the indication that the configuration 1 is a full configuration, the base station 104 includes the MAC partial reset indication in the configuration 1 or element 1. In some alternative implementations, the base station 104 includes the MAC partial reset indication in cases where the base station 104 includes, in the configuration 1 or element 1, the indication that the configuration 1 is a full configuration.

In some implementations, the base station 104 (e.g., the DU 174 or CU 172) does not include, in a configuration or element (e.g., the configuration 1 or element 1) or an RRC message (e.g., events 316, 318) including the configuration or element, an indication related to resetting the UE MAC entity. In such cases, the UE 102 partially resets the UE MAC entity after (e.g., in response to) receiving the first configuration activation command. In such cases, the DU 174 partially resets the DU MAC entity after transmitting the first configuration activation command, receiving 331 the acknowledgement, performing 336 the random access procedure with the UE 102, or determining that the UE 102 connects to the cell 124B.

In some implementations, when the UE 102 determines to reset or resets the UE MAC entity as described above, the UE 102 resets the UE MAC entity before performing 332 the random access procedure or communicating 336 with the base station 104 via the cell 124B. In some implementations, when the UE 102 resets the UE MAC entity, the UE 102 performs at least one of the following actions for the UE MAC entity (i.e., UE MAC reset or full UE MAC reset): (i) initialize Bj for configured logical channel(s) to zero; (ii) stop one or more timers; (iii) consider timeAlignmentTimer(s) as expired, if the UE 102 is configured to perform the random access procedure (e.g., the event 332) in the configuration (e.g., the configuration 1); (iv) set new data indicator(s) (NDI(s)) for UL HARQ process(es) to value 0; (v) set NDI(s) for HARQ process ID(s) to value 0 for monitoring PDCCH in Sidelink resource allocation mode 1; (vi) flush Msg3 buffer; (vii) flush MSGA buffer; (viii) cancel, if any, triggered Scheduling Request procedure; (ix) cancel, if any, triggered Buffer Status Reporting procedure; (x) cancel, if any, triggered Power Headroom Reporting procedure; (xi) cancel, if any, triggered consistent LBT failure; (xii) cancel, if any, triggered BFR; (xiii) cancel, if any, triggered Sidelink Buffer Status Reporting procedure; (xiv) cancel, if any, triggered Pre-emptive Buffer Status Reporting procedure; (xv) cancel, if any, triggered Timing Advance Reporting procedure; (xvi) cancel, if any, triggered Recommended bit rate query procedure; (xvii) cancel, if any, triggered configured uplink grant confirmation; (xviii) cancel, if any, triggered configured sidelink grant confirmation; (xix) cancel, if any, triggered Desired Guard Symbol query; (xx) cancel, if any, triggered Positioning Measurement Gap Activation/Deactivation Request procedure; (xxi) flush soft buffers for DL HARQ process(es); (xxii) for each of the DL HARQ process(es), consider the next received transmission for a TB as the very first transmission; (xxiii) release, if any, Temporary C-RNTI; (xiv) reset one or more counters (e.g., BFI_COUNTERs and/or LBT_COUNTERs); (xxv) etc.

In some implementations, when the DU 174 resets the DU MAC entity, the DU 174 performs at least one of the following actions for the DU MAC entity (i.e., DU MAC reset or full DU MAC reset): (i) stop one or more timers; (ii) consider timeAlignmentTimer(s) that the DU 174 starts and/or maintains for the UE 102 as expired, if the UE 102 is configured to perform the random access procedure (e.g., the event 332) in the configuration (e.g., the configuration 1); (iii) set NDI(s) for DL HARQ process(es) to value 0; (iv) flush soft buffers for UL HARQ process(es); (v) for each of the UL HARQ process(es), consider the next received transmission for a TB as the very first transmission; (vi) reset one or more counters (e.g., BFI_COUNTERs and/or LBT_COUNTERs); (vii) etc.

Depending on the implementation, the UE 102 determines to partially or fully reset the UE MAC entity. In some implementations, when the UE 102 resets the UE MAC entity as described above, the UE 102 fully resets the UE MAC entity (i.e., a full UE MAC reset). In the full UE MAC reset, the UE 102 performs some or all of the actions described above. In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions: (i) consider timeAlignmentTimer(s) of the UE 102 as expired, if the UE 102 is configured to perform the random access procedure (e.g., the event 332) in the configuration (e.g., the configuration 1); (ii) flush Msg3 buffer; (iii) flush MSGA buffer; (iv) release, if any, Temporary C-RNTI; and/or (v) reset one or more counters (e.g., BFI_COUNTERs and/or LBT_COUNTERs).

In some implementations, the partial UE MAC reset further includes at least one of the following actions: (i) cancel, if any, triggered Scheduling Request procedure; (ii) cancel, if any, triggered Buffer Status Reporting procedure; (iii) cancel, if any, triggered Power Headroom Reporting procedure; (iv) cancel, if any, triggered consistent LBT failure; (v) cancel, if any, triggered BFR; (vi) cancel, if any, triggered Sidelink Buffer Status Reporting procedure; (vii) cancel, if any, triggered Pre-emptive Buffer Status Reporting procedure; (viii) cancel, if any, triggered Timing Advance Reporting procedure; (ix) cancel, if any, triggered Recommended bit rate query procedure; (x) cancel, if any, triggered configured uplink grant confirmation; (xi) cancel, if any, triggered configured sidelink grant confirmation; (xii) cancel, if any, triggered Desired Guard Symbol query; and/or (xiii) cancel, if any, triggered Positioning Measurement Gap Activation/Deactivation Request procedure.

In some implementations, the partial UE MAC reset further includes at least one of the following actions: (i) stop a first portion of the one or more timers and retain the rest of the one or more timers; (ii) set new data indicator(s) (NDI(s)) for UL HARQ process(es) to value 0; (iii) set NDI(s) for HARQ process ID(s) to value 0 for monitoring PDCCH in Sidelink resource allocation mode 1; (iv) flush soft buffers for DL HARQ process(es); and/or (v) for each of the DL HARQ process(es), consider the next received transmission for a TB as the very first transmission.

Depending on the implementation, the DU 174 determines to partially or fully reset the DU MAC entity. In some implementations, when the DU 174 resets the DU MAC entity as described above, the DU 174 fully resets the DU MAC entity (i.e., a full DU MAC reset). In the full DU MAC reset, the DU 174 performs some or all of the actions described above. In other implementations, when the DU 174 resets the DU MAC entity as described above, the DU 174 partially resets the DU MAC entity (i.e., a partial DU MAC reset). In the partial DU MAC reset, the DU 174 performs a subset or portion of the some or all of the actions in the full DU MAC reset.

In some implementations, the partial DU MAC reset includes at least one of the following actions in the partial MAC reset: (i) consider timeAlignmentTimer(s), that the DU 174 starts and/or maintains for the UE 102, as expired, if the UE 102 is configured to perform the random access procedure (e.g., the event 332) in the configuration (e.g., the configuration 1); and/or (ii) reset one or more counters (e.g., BFI_COUNTERs and/or LBT_COUNTERs).

In some implementations, the partial DU MAC reset includes at least one of the following actions for the MAC entity (i.e., DU MAC reset): (i) stop a first portion of the one or more timers and retain the rest of the one or more timers; (ii) set NDI(s) for DL HARQ process(es) to value 0; (iii) flush soft buffers for UL HARQ process(es); (iv) for each of the UL HARQ process(es), consider the next received transmission for a TB as the very first transmission; and/or (v) reset one or more counters (e.g., BFI_COUNTERs and/or LBT_COUNTERs).

In some implementations, the configuration 1 do or do not include one or more RLC reestablishment indications (e.g., reestablishRLC field(s)) configuring the UE 102 to reestablish one or more RLC entities (e.g., RLC 206B) that the UE 102 uses to communicate with the DU 174 (e.g., the events 302, 304, 318, 320, 324, 330, and/or 331). If the configuration 1 includes the RLC reestablishment indication configuring the UE 102 to reestablish an RLC entity (e.g., RLC 206B) that the UE 102 uses to communicate RLC PDU(s) with the base station 104 (e.g., the events 302, 304, 318, 320, 324, 330, and/or 331), the UE 102 reestablishes the RLC entity in response to the RLC reestablishment indication. In some implementations, the UE 102 reestablishes the RLC entity before performing 332 the random access procedure or communicating 336 with the base station 104 via the cell 124B. In other implementations, the UE 102 reestablishes the RLC entity while or after performing 332 the random access procedure. In some implementations, when the UE 102 reestablishes the RLC entity, the UE 102 performs at least one of the following actions for the RLC entity: (i) discard RLC SDU(s), RLC SDU segment(s), and RLC PDU(s), if any; (ii) stop and reset timer(s), if running; (iii) reset state variables to initial values. In some implementations, the state variables and timer(s) are currently defined (e.g., in 3GPP specification 38.322).

Otherwise, if the configuration 1 does not include the RLC reestablishment indication for the RLC entity, the UE 102 refrains from reestablishing the RLC entity upon or when receiving the first configuration activation command. In other words, the UE 102 refrains from preforming the actions for reestablishing the RLC entity of the UE 102 upon or when receiving the first configuration activation command. In some implementations, if the configuration 1 or element 1 does not include the RLC reestablishment indication and includes an indication that the configuration 1 is a full configuration, the UE 102 reestablishes the RLC entity of the UE 102 upon or when receiving the first configuration activation command. Otherwise, if the configuration 1 or element 1 does not include the RLC reestablishment indication, and the indication that the configuration 1 is a full configuration, the UE 102 refrains from reestablishing the RLC entity upon or when receiving the first configuration activation command.

Similarly, the DU 174 reestablishes an RLC entity (e.g., NR RLC 206B) that the DU 174 uses to communicate with the RLC entity of the UE 102 (e.g., the events 302, 304, 318, 320, 324, 330, and/or 331) in response to the RLC reestablishment indication. In some implementations, the DU 174 reestablishes the RLC entity after transmitting the first configuration activation command, receiving an acknowledgement for the first configuration activation command from the UE 102, or determining that the UE 102 connects to the cell 124B. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the RLC entity, the DU 174 performs at least one of the following actions for the RLC entity: (i) discard RLC SDU(s), RLC SDU segment(s), and RLC PDU(s), if any; (ii) stop and reset timer(s), if running; and/or (iii) reset state variables to initial values. In some implementations, the state variables and timer(s) are currently defined (e.g., in 3GPP specification 38.322).

In some implementations, the description for the configuration 1 above applies to the configuration(s) 2, . . . , N as well.

In some implementations, after (e.g., in response to) determining that the UE 102 connects to the cell 124B, the CU 172 transmits 338 a CU-to-DU message (e.g., a UE Context Modification Request message) to the DU 174 to indicate to the DU 174 to stop communicating with the UE 102 and/or to release or suspend resources of the cell 124A, configured for the UE 102. In further implementations, in response, the DU 174 stops communicating on the cell 124A with the UE 102, releases or suspends resources of the cell 124A, configured for the UE 102, and/or transmits 340 a DU-to-CU message (e.g., a UE Context Modification Response message) to the CU-172. The events 338 and 340 are collectively referred to in FIG. 3 as a procedure 394 (e.g., UE Context Modification procedure).

Referring next to FIG. 4, in a scenario 400, the base station 104 includes a CU 172, a source DU (S-DU) 174A and a target DU (T-DU) 174B. The S-DU 174A operates the cell 124A and, in some implementations, operates the cell 124B, while the T-DU 174B operates the cell 124C. The scenario 400 is similar to the scenario 300. Thus, the descriptions for the scenario 300 can generally apply to the scenario 400. In particular, the descriptions for cell 124B in the scenario 300 can apply to the cell 124C. The events 404, 406, 490, 492, 416, 418, 420, 422 are collectively referred to in FIG. 4 as a serving cell configuration procedure 480. The events 424, 426, 428, 430, 431, 432, 434, 436, 494 are collectively referred to in FIG. 4 as a serving cell change procedure 482.

In some implementations, after (e.g., in response to) determining that the UE 102 connects to the cell 124C, the CU 172 transmits 438 a CU-to-DU message (e.g., a UE Context Release Command message) to the S-DU 174A to release a UE context of the UE 102. In response, the S-DU 174A releases a UE context of the UE 102 and transmits 440 a DU-to-CU message (e.g., a UE Context Release Complete message) to the CU-172. Alternatively, the CU 172 transmits 438 a CU-to-DU message (e.g., a UE Context Modification Request message) to the S-DU 174A to indicate to the S-DU 174A to stop communicating with the UE 102 and/or to release or suspend resources of the cell 124A, configured for the UE 102. In response, in some such implementations, the S-DU 174A stops communicating on the cell 124A with the UE 102, releases or suspends resources of the cell 124A, configured for the UE 102, and/or transmits 440 a DU-to-CU message (e.g., a UE Context Modification Response message) to the CU-172.

Referring next to FIG. 5A, in a scenario 500A, the base station 106 operates as an MN, and the base station 104 operates as an SN. The SN 104 includes a CU 172 and a DU 174. The scenario 500A is similar to the scenario 300, except that the scenario 500A is a DC scenario, and the scenario 300 is a single connectivity (SC) scenario. Initially, the UE 102 in DC communicates with the MN 106 and with SN 104. In the event 502, the UE 102 communicates with the DU 174 on cell 124A and communicates with the CU 172 via the DU 174, using a first configuration, similar to the event 302. In some implementations, the UE 102 in DC communicates 502 UL PDUs and/or DL PDUs with the MN 106 and/or SN 104 via radio bearers, which in some further implementations include SRBs and/or DRB(s). In further implementations, the MN 106 and/or the SN 104 configure the radio bearers to the UE 102. The UE 102 in DC communicates 502 UL PDUs and/or DL PDUs with the SN 104 on an SCG that the SN 104 configures for communication with the UE 102. The UE 102 in DC communicates UL PDUs and/or DL PDUs with the MN 106 on an MCG in accordance with a MN configuration (i.e., MCG configuration). In some implementations, the first configuration is an SN configuration (i.e., SCG configuration). In the MN configuration, the MN 106 configures the MCG, which includes at least one serving cell (e.g., the cell 126 and/or other cell(s)) operated by the MN 106. In the first configuration, the SN 106A configures the SCG which includes at least one serving cell (e.g., the cell 124A and/or other cell(s)) operated by the SN 104. In some implementations, the MN configuration includes multiple configuration parameters and the UE 102 receives the configuration parameters in one or more RRC messages from the MN 106. In other implementations, the first configuration includes multiple configuration parameters, and the UE 102 receives the configuration parameters in one or more RRC messages from the SN 104 (e.g., via the MN 106) or on an SRB (e.g., SRB3) that the MN 106 or SN 104 configures to exchange RRC messages between the UE 102 and the SN 104.

In some implementations, while communicating in DC with the MN 106 and SN 104, the MN 106 performs 580 a fast serving cell configuration procedure with the UE 102, similar to the procedure 380. In some implementations, while communicating in DC with the MN 106 and SN 104, the UE 102 transmits the at least one measurement report to the CU 172 via the DU 174 and cell 124A in the events 504 and 506, similar to the events 304 and 306, respectively. In other implementations, while communicating in DC with the MN 106 and SN 104, the UE 102 transmits 505 at least one measurement report to the MN 106 via the cell 126. The MN 106 in turn transmits 507 the at least one measurement report to the CU 172. In some implementations, the MN 106 generates at least one SN message, including the at least one measurement report, and transmits the at least one SN message to the CU 172 in the event 507. In some implementations, the at least one SN message include RRC Transfer message(s) and/or SN Modification Request message(s).

After (e.g., in response to) receiving the at least one measurement report or while the base station 104 communicates with the UE 102, the base station 104 determines to prepare the cell 124B for the UE 102, as described for FIG. 3. The events 590, 592, 516, 518, 520, 522, 524, 526, 528, 530, 531, 532, 534, 536, and 594 are similar to the events 390, 392, 316, 318, 320, 322, 324, 326, 328, 330, 331, 332, 334, 336, and 394, respectively. After receiving the first configuration activation command, transmitting the acknowledgement, or determining that the UE 102 connects to the cell 124B, the UE 102 operating in DC with the MN 106 and SN 104 communicates 536 with the SN 104 on the cell 124B in accordance with the configuration 1, similar to the event 336.

The events 504, 506, 505, 507, 590, 592, 516, 518, 520, 522 are collectively referred to in FIG. 5A as a serving cell configuration procedure 581A. The events 524, 526, 528, 530, 531, 532, 534, 536, 594 are collectively referred to in FIG. 5A as a serving cell change procedure 583.

Referring next to FIG. 5B, a scenario 500B is generally similar to the scenario 500A, except that the SN 104 transmits 517, 519 the RRC reconfiguration message to the UE 102 via the MN 106 and receives 521, 523 the RRC reconfiguration complete message from the UE 102 via the MN 106. In some implementations, the SN 104 generates a first SN message (e.g., SN Modification Required message, SN Modification Required message, or RRC Transfer message), including the RRC reconfiguration message, and transmits the first SN message to the MN 106 in the event 517. In some implementations, the MN 106 generates a second SN message (e.g., SN Reconfiguration Complete message or RRC Transfer message), including the RRC reconfiguration complete message, and transmits the second SN message to the SN 104 in the event 523.

The events 504, 506, 505, 507, 590, 592, 517, 519, 521, 523 are collectively referred to in FIG. 5B as a serving cell configuration procedure 581B.

Referring next to FIG. 6A, in a scenario 600A, the base station 106 operates as an MN, and the base station 104 operates as an SN, similar to the scenarios 300-500B. The SN 104 includes a CU 172, an S-DU 174A, and a T-DU 174B, similar to the base station 104 in the scenario 400. The events 604, 606, 605, 607, 690, 692, 616, 618, 620, 622 are collectively referred to in FIG. 6A as a serving cell configuration procedure 681A. The events 624, 626, 628, 630, 631, 632, 634, 636, 694 are collectively referred to in FIG. 6A as a serving cell change procedure 683. Further, it will be understood that some descriptions with regard to the scenarios 300-500B can apply to the scenario 600A, but to one or both of the S-DU 174A or the T-DU 174B (e.g., events 608, 610, 632, 634, etc.).

Referring next to FIG. 6B, a scenario 600B similar to the scenarios 300-500B and 600A, except that that the SN 104 transmits 617, 619 the RRC reconfiguration message to the UE 102 via the MN 106 and receives 621, 623 the RRC reconfiguration complete message from the UE 102 via the MN 106. The events 604, 606, 605, 607, 690, 692, 617, 619, 621, 623 are collectively referred to in FIG. 6B as a serving cell configuration procedure 681B.

Referring next to FIG. 7A, in a scenario 700A, the base station 104 operates as an MN and an SN, similar to the scenarios 300-600B. The base station 104 includes a CU 172, a master DU (M-DU) 174A, and a secondary DU (S-DU) 174B. The CU 172 operates with the M-DU 174A as an MN, similar to the base station 104 in the FIG. 3 or the MN 106 in FIGS. 5A-6B, and the CU 172 operates with the S-DU 174B as an SN, similar to the SN 104 in FIGS. 5A-6B.

In the scenario 700A, the UE 102 initially communicates 702 in DC with the M-DU 174A and S-DU 174B and communicates 702 with the CU 172 via the M-DU 174A and S-DU 174B. In the event 702, the UE 102 communicates with the S-DU 174B on cell 124A and communicates with the CU 172 via the S-DU 174B using a first configuration. Events 704 and 706 are similar to the events 304 and 306. In some implementations, the UE 102 transmits 705 at least one measurement report to the M-DU 174A, similar to the event 304. The M-DU 174A in turn transmits 707 at least one DU-to-CU message including the at least one measurement report to the CU 172, similar to the event 306.

The events 704, 706, 705, 707, 790, 792, 716, 718, 720, 722 are collectively referred to in FIG. 7A as a serving cell configuration procedure 781A. The events 724, 726, 728, 730, 731, 732, 734, 736, 794 are collectively referred to in FIG. 7A as a serving cell change procedure 783.

Referring next to FIG. 7B, a scenario 700B similar to the scenarios 300-600B and 700A, except that that the CU 172 transmits 717, 719 the RRC reconfiguration message to the UE 102 via the M-DU 174A and receives 721, 723 the RRC reconfiguration complete message from the UE 102 via the M-DU 174A. The events 704, 706, 705, 707, 790, 792, 717, 719, 721, 723 are collectively referred to in FIG. 7B as a serving cell configuration procedure 781B.

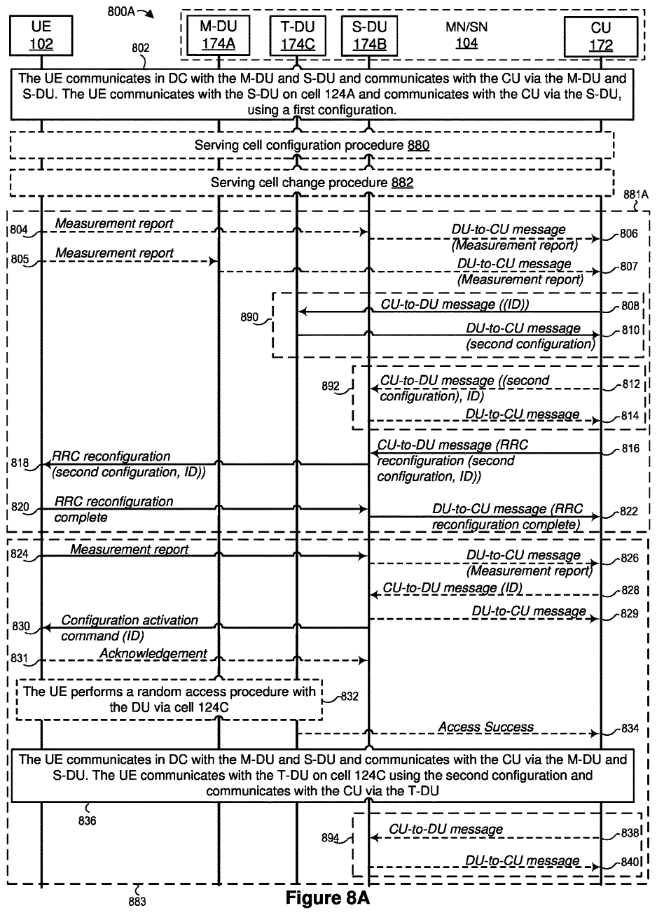

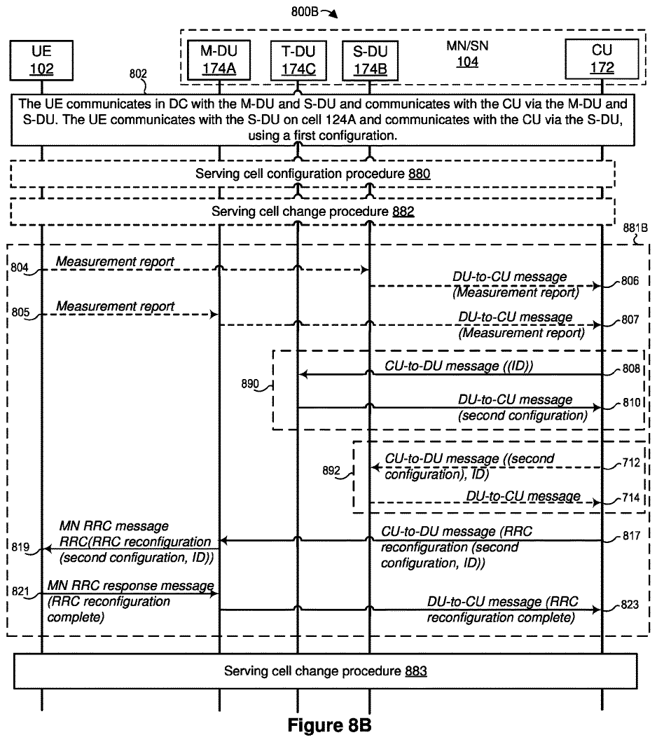

Referring next to FIG. 8A, in a scenario 800A, the base station 104 operates as an MN and an SN, similar to the scenarios 300-700B. The base station 104 includes a CU 172, a master DU (M-DU) 174A, a secondary DU (S-DU) 174B, and a T-DU 174C. The CU 172 operates with the M-DU 174A as an MN and operates with the S-DU 174B as an SN. The events 804, 806, 805, 807, 890, 892, 816, 818, 820, 822 are collectively referred to in FIG. 8A as a serving cell configuration procedure 881A. The events 824, 826, 828, 830, 831, 832, 834, 836, 894 are collectively referred to in FIG. 8A as a serving cell change procedure 883. Further, it will be understood that some descriptions with regard to the scenarios 300-700B can apply to the scenario 800A, but to one, some, or all of the M-DU 174A, S-DU 174B, or the T-DU 174C (e.g., events 808, 810, 832, 834, etc.).

Referring next to FIG. 8B, a scenario 800B similar to the scenarios 300-700B and 800A, except that that the CU 172 transmits 817, 819 the RRC reconfiguration message to the UE 102 via the M-DU 174A and receives 821, 823 the RRC reconfiguration complete message from the UE 102 via the M-DU 174A. The events 804, 806, 805, 807, 890, 892, 817, 819, 821, 823 are collectively referred to in FIG. 8A as a serving cell configuration procedure 881B.

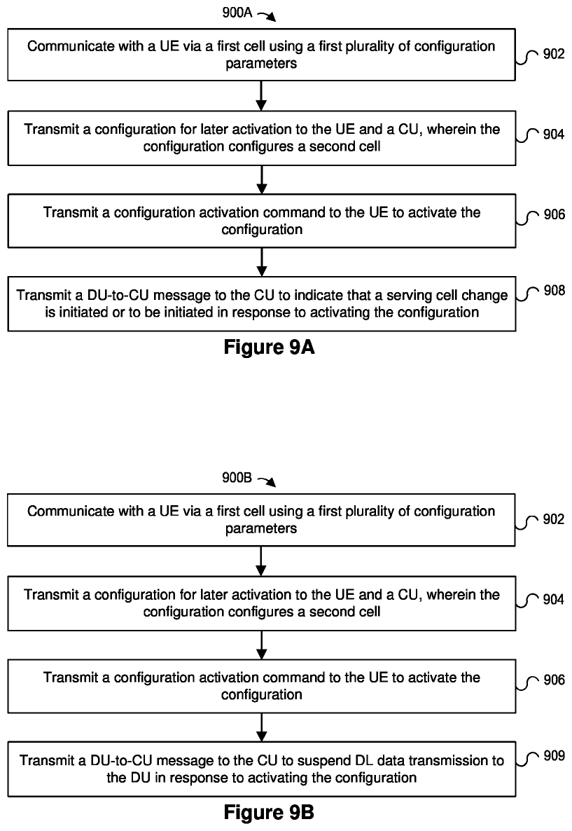

Next, several example methods, which can be implemented in a UE (e.g., the UE 102) or a RAN node (e.g., the base station 104/106, or the DU 174) to handle data communication in a serving cell change, are discussed next with reference to FIGS. 9A-12B. Examples and implementations described for FIGS. 3-8B can apply to FIGS. 9A-12B.

FIG. 9A illustrates a method 900A, which can be implemented by a DU (e.g., the DU 174), for handling data communication in serving cell change with a UE (e.g., the UE 102).

The method 900A begins at block 902, where the DU communicates with a UE via a first cell using a first plurality of configuration parameters (e.g., events 302, 380, 402, 480, 502, 580, 582, 581A, 581B, 602, 680, 682, 681A, 681B, 702, 780, 782, 781A, 781B, 802, 880, 882, 881A, 881B). At block 904, the DU transmits a configuration for later activation to the UE and a CU, wherein the configuration configures a second cell (e.g., events 310, 316, 318, 380, 410, 416, 418, 480, 510, 516, 518, 517, 519, 580, 581A, 581B, 610, 616, 618, 617, 619, 680, 681A, 681B, 710, 716, 718, 717, 719, 780, 781A, 781B, 810, 816, 818, 817, 819, 880, 881A, 881B). At block 906, the DU transmits a configuration activation command to the UE to activate the configuration (e.g., events 330, 382, 430, 482, 530, 583, 582, 630, 683, 682, 730, 783, 782, 830, 883, 882). At block 908, the DU transmits a DU-to-CU message to the CU to indicate that a serving cell change is initiated or to be initiated in response to activating the configuration (e.g., events 329, 382, 429, 482, 529, 583, 582, 629, 683, 682, 729, 783, 782, 829, 883, 882).

FIG. 9B is a flow diagram of an example method 900B similar to the method 900A, except that method 900B includes block 909 instead of block 908. At block 909, the DU transmits a DU-to-CU message to the CU to suspend DL data transmission to the DU in response to activating the configuration (e.g., events 329, 382, 429, 482, 529, 583, 582, 629, 683, 682, 729, 783, 782, 829, 883, 882).

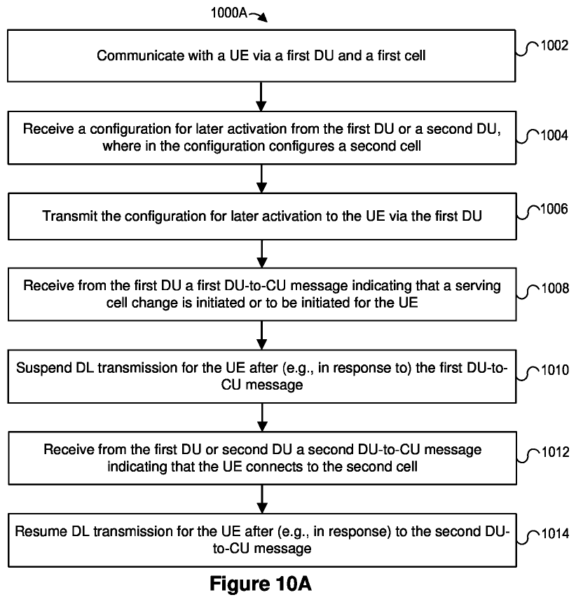

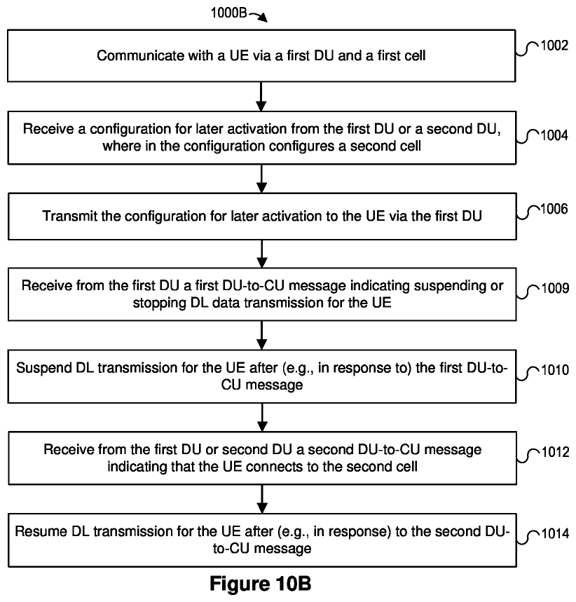

FIG. 10A illustrates a method 1000A, which can be implemented by a CU (e.g., the CU 172), for handling data communication in a serving cell change with a UE (e.g., the UE 102).

The method 1000A begins at block 1002, where the CU communicates with the UE via a first DU and a first cell (e.g., events 302, 380, 402, 480, 502, 580, 582, 581A, 581B, 602, 680, 682, 681A, 681B, 702, 780, 782, 781A, 781B, 802, 880, 882, 881A, 881B). At block 1004, the CU receives a configuration for later activation from the first DU or a second DU, wherein the configuration configures a second cell (e.g., events 310, 380, 410, 480, 510, 580, 581A, 581B, 680, 681A, 681B, 710, 780, 781A, 781B, 810, 880, 881A, 881B). At block 1006, the CU transmits the configuration for later activation to the UE via the first DU (e.g., events 316, 318, 380, 416, 418, 480, 516, 518, 517, 519, 580, 581A, 581B, 616, 618, 617, 619, 680, 681A, 681B, 716, 718, 717, 719, 780, 781A, 781B, 816, 818, 817, 819, 880, 881A, 881B). At block 1008, the CU receives, from the first DU, a first DU-to-CU message indicating that a serving cell change is initiated or to be initiated for the UE (e.g., events 329, 382, 429, 482, 529, 583, 582, 629, 683, 682, 729, 783, 782, 829, 883, 882). At block 1010, the CU suspends DL transmission for the UE after (e.g., in response to) the first DU-to-CU message. At block 1012, the CU receives, from the first DU or second DU, a second DU-to-CU message indicating that the UE connects to the second cell (e.g., events 334, 382, 434, 482, 534, 583, 582, 634, 683, 682, 734, 783, 782, 834, 883, 882). At block 1014, the CU resumes DL transmission for the UE after (e.g., in response to) the second DU-to-CU message (e.g., events 336, 382, 436, 482, 536, 583, 582, 636, 683, 682, 736, 783, 782, 836, 883, 882).

FIG. 10B is a flow diagram of an example method 1000B similar to the method 1000A, except that method 1000B includes block 1009 instead of block 1008. At block 1009, the CU receives, from the first DU, a first DU-to-CU message indicating suspending or stopping DL data transmission for the UE (e.g., events 329, 382, 429, 482, 529, 583, 582, 629, 683, 682, 729, 783, 782, 829, 883, 882).

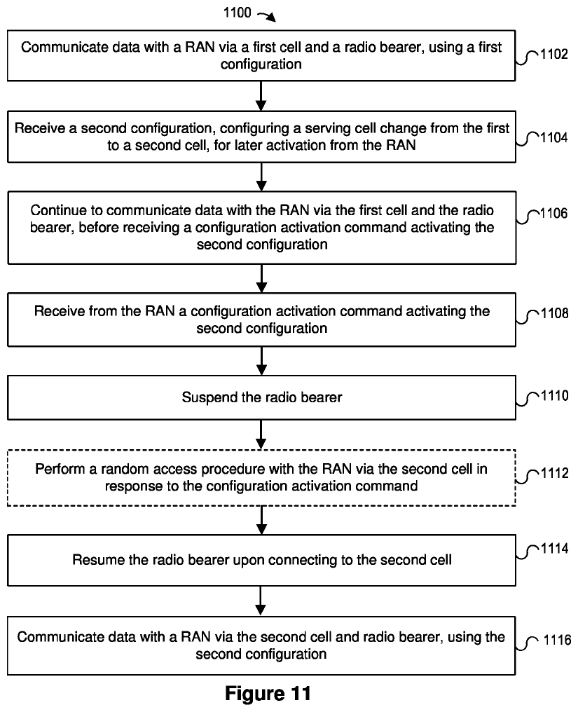

FIG. 11 illustrates a method 1100, which can be implemented by a UE (e.g., the UE 102), for managing data communication with a RAN (e.g., the DU 174, CU 172, base station 104/106, or RAN 105).

The method 1100 begins at block 1102, where the UE communicates data with a RAN via a first cell and a radio bearer using a first configuration (e.g., events 302, 380, 402, 480, 502, 580, 582, 581A, 581B, 602, 680, 682, 681A, 681B, 702, 780, 782, 781A, 781B, 802, 880, 882, 881A, 881B). At block 1104, the UE receives a second configuration, configuring a serving cell change from the first cell to a second cell, for later activation from the RAN (e.g., events 316, 318, 380, 416, 418, 480, 516, 518, 517, 519, 580, 581A, 581B, 616, 618, 617, 619, 680, 681A, 681B, 716, 718, 717, 719, 780, 781A, 781B, 816, 818, 817, 819, 880, 881A, 881B). At block 1106, the UE continues to communicate data with the RAN via the first cell and the radio bearer before receiving a configuration activation command activating the second configuration. At block 1108, the UE receives, from the RAN, a configuration activation command activating the second configuration (e.g., events 330, 382, 430, 482, 530, 583, 582, 630, 683, 682, 730, 783, 782, 830, 883, 882). At block 1110, the UE suspends the radio bearer. In some implementations, at block 1112, the UE performs a random access procedure with the RAN via the second cell in response to the configuration activation command (e.g., events 332, 382, 432, 482, 532, 583, 582, 632, 683, 682, 732, 783, 782, 832, 883, 882). At block 1114, the UE resumes the radio bearer upon connecting to the second cell. At block 1116, the UE communicates data with a RAN via the second cell and radio bearer using the second configuration (e.g., events 336, 382, 436, 482, 536, 583, 582, 636, 683, 682, 736, 783, 782, 836, 883, 882).

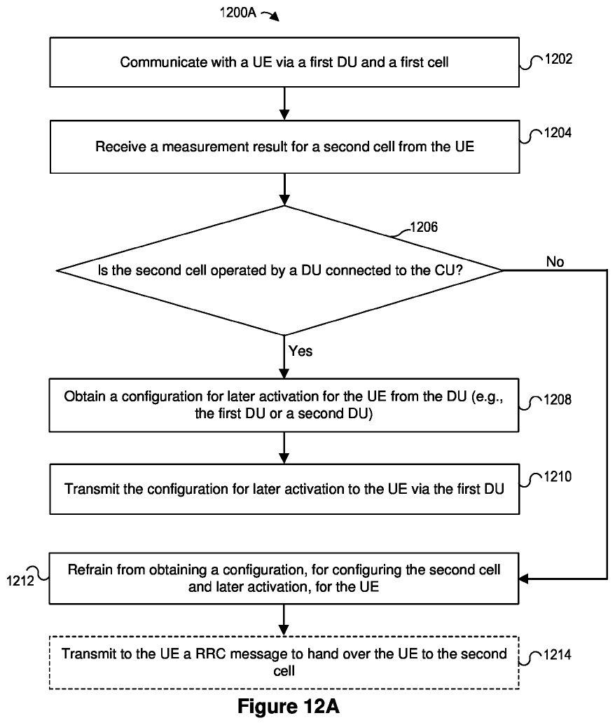

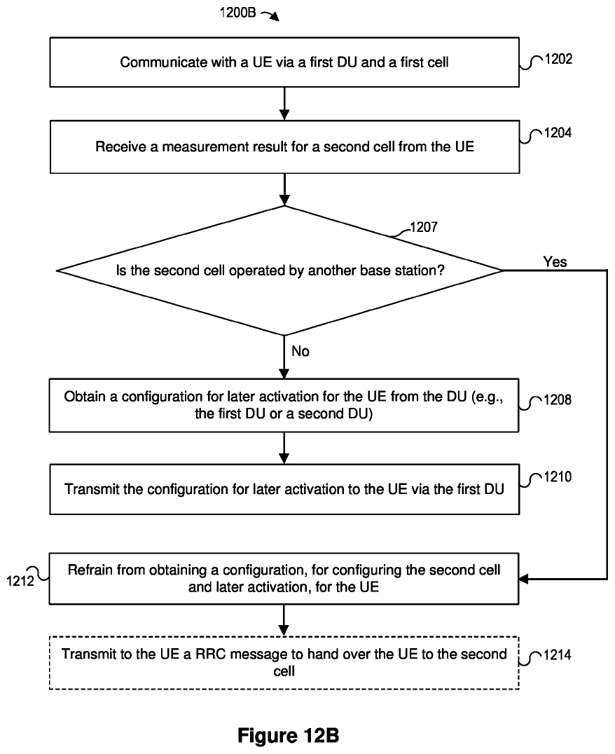

FIG. 12A illustrates a method 1200A, which can be implemented by a CU (e.g., the CU 172), for handling data communication in a serving cell change with a UE (e.g., the UE 102).

The method 1200A begins at block 1202, where the CU communicates with a UE via a first DU and a first cell (e.g., events 302, 380, 402, 480, 502, 580, 582, 581A, 581B, 602, 680, 682, 681A, 681B, 702, 780, 782, 781A, 781B, 802, 880, 882, 881A, 881B). At block 1204, the CU receives a measurement result for a second cell from the UE (e.g., events 304, 306, 380, 404, 406, 480, 504, 506, 505, 507, 580, 581A, 581B, 604, 606, 605, 607, 680, 681A, 681B, 704, 706, 705, 707, 780, 781A, 781B, 804, 806, 805, 807, 880, 881A, 881B). At block 1206, the CU determines whether the second cell is operated by a DU connected to the CU. If the CU determines that the second cell is operated by a DU connected to the CU at block 1206, the flow proceeds to block 1208. At block 1208, the CU obtains a configuration for later activation for the UE from the DU (e.g., the first DU or a second DU) (e.g., events 310, 380, 410, 480, 510, 580, 581A, 581B, 680, 681A, 681B, 710, 780, 781A, 781B, 810, 880, 881A, 881B). At block 1210, the CU transmits the configuration for later activation to the UE via the first DU (e.g., events 316, 318, 380, 416, 418, 480, 516, 518, 517, 519, 580, 581A, 581B, 616, 618, 617, 619, 680, 681A, 681B, 716, 718, 717, 719, 780, 781A, 781B, 816, 818, 817, 819, 880, 881A, 881B). Otherwise, if the CU determines that the second cell is not operated by a DU connected to the CU at block 1206, the flow proceeds to block 1212. At block 1212, the CU refrains from obtaining a configuration, for configuring the second cell and later activation, for the UE. In some implementations, at block 1214, the CU transmits, to the UE, an RRC message to hand over the UE to the second cell.

FIG. 12B is a flow diagram of an example method 1200B similar to the method 1200A, except that method 1200B includes block 1207 instead of block 1206. At block 1207, the CU determines whether the second cell is operated by another base station. If the CU determines that the second cell is operated by another base station at block 1207, the flow proceeds to block 1208. Otherwise, if the CU determines that the second cell is not operated by another base station (i.e., the second cell is operated by the base station), the flow proceeds to block 1212.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “configuration activation command” can be replaced by “serving cell change command”, “Layer 1/Layer 2 switching command”, “lower layer switching command” or “lower layer serving cell change command”. The “fast serving cell configuration procedure” can be replaced by “fast serving cell change procedure”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a centralized unit (CU) of a distributed base station that includes the CU and a distributed unit (DU), the method comprising:
transmitting, to a user equipment (UE) via the DU and in a first cell, a configuration for performing a serving cell change to a second cell subsequent to an activation command; and
in response to receiving a DU-to-CU message subsequent to the transmitting of the configuration but prior to receiving an indication that the UE has connected to the second cell, suspending downlink (DL) transmissions of data packets to the UE.

2. The method of claim 1, further comprising:
in response to receiving the indication that the UE has connected to the second cell, resuming the DL transmissions of the data packets to the UE.

3. The method of claim 1, wherein the suspending of the DL transmissions includes:
buffering the data packets at the CU.

4. The method of claim 1, further comprising:
subsequent to the transmitting of the configuration, transmitting the activation command to the UE.

5. The method of claim 4, further comprising:
transmitting, along with the configuration, an identifier assigned to the configuration; and
including the identifier in the activation command.

6. The method of claim 5, wherein:
the configuration and the identifier assigned to the configuration are transmitted in a radio resource control (RRC) message.

7. The method of claim 4, wherein the transmitting of the activation command is in response to receiving a Layer 1 (L1) measurement report from the UE.

8. The method of claim 7, further comprising:
providing an L1 measurement configuration to the UE, wherein the L1 measurement report is generated according to the L1 measurement configuration.

9. The method of claim 1, wherein the DU-to-CU message includes an indication that the serving cell change is initiated.

10. The method of claim 1, wherein the DU-to-CU message includes a request to suspend the DL transmissions of the data packets.

11. The method of claim 1,
wherein the DU is a first DU;
the method further comprising:
prior to the transmitting of the configuration, communicating with the UE in the first cell via the first DU; and
receiving the configuration for performing the serving cell change from a second DU.

12. The method of claim 1, wherein:
the distributed base station operates a secondary node (SN) to support dual activity of the UE via a master node (MN) and the SN.

13. The method of claim 1, wherein:
the distributed base station operates as an MN to support dual activity of the UE via the MN and an SN.

14. A method in a distributed unit (DU) of a distributed base station that includes the DU and a centralized unit (CU), the method comprising:
communicating with a user equipment (UE) in a first cell in accordance with first configuration parameters;
transmitting, to the UE, a configuration for performing a serving cell change to a second cell subsequent to an activation command;
transmitting, to the UE and in response to a measurement report, the activation command; and
in response to the transmitting of the activation command, transmitting, to the CU, an indication to suspend downlink (DL) transmissions of data packets to the UE.

15. An apparatus functioning as a centralized unit (CU) in a distributed radio access network (RAN) that includes the CU and a distributed unit (DU), the apparatus comprising:
processing hardware configured to:
transmit, to a user equipment (UE) via the DU and in a first cell, a configuration for performing a serving cell change to a second cell subsequent to an activation command; and
in response to reception of a DU-to-CU message subsequent to transmission of the configuration but prior to reception of an indication that the UE has connected to the second cell, suspend downlink (DL) transmissions of data packets to the UE.

16. The apparatus of claim 15, wherein the processing hardware is further configured to:
in response to reception of the indication that the UE has connected to the second cell, resume the DL transmissions of the data packets to the UE.

17. The apparatus of claim 15, wherein the processing hardware configured to suspend the DL transmissions is configured to:
buffer the data packets at the CU.

18. The apparatus of claim 15, wherein the processing hardware is further configured to:
subsequent to transmission of the configuration, transmit the activation command to the UE.

19. The apparatus of claim 18, wherein the processing hardware is further configured to:
transmit, along with the configuration, an identifier assigned to the configuration; and
include the identifier in the activation command.

20. The apparatus of claim 15, wherein:
the DU is a first DU; and
the processing hardware is further configured to:
prior to transmission of the configuration, communicate with the UE in the first cell via the first DU; and
receive the configuration for performing the serving cell change from a second DU.
